(19) United States
(12) Patent Application Publication
(10) Pub. No.: US 2016/0365555 A1
(43) Pub. Date: Dec. 15, 2016

(54) SEPARATOR WASHING METHOD, SEPARATOR PRODUCING METHOD, AND FILM WASHING METHOD

(71) Applicant: Sumitomo Chemical Company, Limited, Tokyo (JP)

(72) Inventors: Yasuo SHINOHARA, Tsukuba-shi (JP); Akihiko SHIN, Daegu (KR); Tsutomu FURUYA, Niihama-shi (JP); Keita GENDAI, Niihama-shi (JP); Tatsuya KATAOKA, Niihama-shi (JP); Yoichi KAWAMURA, Niihama-Shi (JP)

(21) Appl. No.: 15/177,934

(22) Filed: Jun. 9, 2016

(30) Foreign Application Priority Data
Jun. 11, 2015 (JP) 2015-118465
Jun. 11, 2015 (JP) 2015-118699
Nov. 13, 2015 (JP) 2015-223427

(51) Int. Cl. H01M 2/14; H01M 2/16; H01M 10/0525

(52) U.S. Cl. CPC H01M 2/145; H01M 10/0525; H01M 2/1653

(57) ABSTRACT

The present invention provides a washing method and the like suitable for a long and porous battery separator and a separator producing method including the washing method. The washing method of the present invention includes the steps of (i) transferring a separator in its longitudinal direction and (ii) washing the separator by causing the separator, which is being transferred, to sequentially pass through washing waters in washing tanks.

This Nonprovisional application claims priority under 35 U.S.C. §119 on Patent Applications No. 2015-118699 and No. 2015-118465 filed in Japan on Jun. 11, 2015, and on Patent Application No. 2015-223427 filed in Japan on Nov. 13, 2015, the entire contents of which are hereby incorporated by reference.

### TECHNICAL FIELD

The present invention relates to (i) a washing method for washing a separator for use in a battery such as a lithium-ion secondary battery and (ii) a producing method for producing such a separator.

### BACKGROUND ART

A lithium-ion secondary battery includes therein a positive electrode and a negative electrode which are separated by a separator that is in a form of film and is porous. A method for producing a film such as the separator includes a washing treatment for later removing an unnecessary substance from the film which has been once prepared.

For example, if not limited to a separator, techniques disclosed in Patent Literatures 1 and 2 are known as techniques to wash a sheet or a film. Patent Literature 1 discloses a washing tank including two tanks for roughly and thoroughly washing a heat-sealing multilayer sheet in sequence. Patent Literature 2 discloses a washing section having a plurality of stages for soak-washing and spray-washing an optical plastic film in sequence.

### CITATION LIST

### Patent Literatures

Patent Literature 1

Japanese Patent Application Publication, Tokukai, No. 2001-170933 (Publication Date: Jun. 26, 2001) Patent Literature 2

Japanese Patent Application Publication, Tokukai, No. 2007-105662 (Publication Date: Apr. 26, 2007)

### SUMMARY OF INVENTION

### Technical Problem

A porous separator and an intermediate product film thereof have mechanical strength which is lower than that of a simple non-porous film. Therefore, such a separator and a film are more likely to be folded or torn during washing. In a case where the washing is insufficient, air permeability of the porous separator decreases. Patent Literatures 1 and 2 do not consider using a plurality of washing tanks for washing such a porous separator or an intermediate product film thereof.

In view of the above characteristics of the separator, an object of the present invention is to provide (i) a washing method which is suitable for a separator and an intermediate product film thereof and (ii) a production method for producing a separator with use of the washing method.

### Solution to Problem

In order to attain the object, a separator washing method of the present invention is a method for washing a battery separator which is long and porous, and the separator washing method includes the steps of: transferring the battery separator in a longitudinal direction of the battery separator; and washing the battery separator by causing the battery separator, which is being transferred, to sequentially pass through a washing liquid in a first washing tank and a washing liquid in a second washing tank.

A separator producing method of the present invention includes a forming step of forming a long and porous battery separator and the steps of the above described separator washing method, the steps of the separator washing method being carried out after the forming step.

The film washing method of the present invention is a method for obtaining a battery separator which is long and porous, and the film washing method includes the steps of transferring a film which is long and is an intermediate product of the battery separator in a longitudinal direction of the film; and washing the film by causing the film, which is being transferred, to sequentially pass through a washing liquid in a first washing tank and a washing liquid in a second washing tank.

Another separator producing method of the present invention includes a forming step of forming a film which is long and is an intermediate product of a long and porous battery separator and the steps of the above described film washing method, the steps of the film washing method being carried out after the forming step.

### Advantageous Effects of Invention

The separator washing method of the present invention is a method for washing a battery separator which is long and porous, and the separator washing method includes the steps of: transferring the battery separator in a longitudinal direction of the battery separator; and washing the battery separator by causing the battery separator, which is being transferred, to sequentially pass through a washing liquid in a first washing tank and a washing liquid in a second washing tank. With the configuration, it is possible to wash a porous separator whose mechanical strength is lower than a non-porous film while inhibiting a fold and a tear, and it is therefore possible to carry out sufficient washing. This makes it possible to bring about an effect of obtaining a battery separator having an air permeability higher than that of a conventional battery separator.

Moreover, the present invention includes a forming step of forming a long and porous battery separator and the steps of the separator washing method, the steps of the separator washing method being carried out after the forming step. This makes it possible to bring about an effect of producing the battery separator in which a fold and a tear are inhibited and which has an air permeability higher than that of a conventional battery separator.

The film washing method of the present invention is a method for obtaining a battery separator which is long and porous and the film washing method includes the steps of: transferring a film which is long and is an intermediate product of the battery separator in a longitudinal direction of the film; and washing the film by causing the film, which is being transferred, to sequentially pass through a washing liquid in a first washing tank and a washing liquid in a second washing tank. With the configuration, it is possible to bring about an effect of (i) washing the film which is an intermediate product of a battery separator, which is a porous film and whose mechanical strength is lower than that of a non-porous film, while inhibiting a fold and a tear, (ii) carrying out sufficient washing, and (iii) obtaining a battery separator having an air permeability higher than that of a conventional battery separator.

Moreover, the present invention includes a forming step of forming a film which is long and is an intermediate product of a long and porous battery separator and the steps of the above described film washing method, the steps of the film washing method being carried out after the forming step. This makes it possible to bring about an effect of producing the battery separator in which a fold and a tear are inhibited and which has an air permeability higher than that of a conventional battery separator.

### BRIEF DESCRIPTION OF DRAWINGS

FIG. 1 is a schematic view illustrating a cross sectional configuration of a lithium-ion secondary battery.

FIG. 2 is a schematic view illustrating a detailed configuration of the lithium-ion secondary battery illustrated in FIG. 1.

FIG. 3 is a schematic view illustrating another configuration of the lithium-ion secondary battery illustrated in FIG. 1.

FIG. 4 is a cross-sectional view illustrating a configuration of a washing device used in a washing method of Embodiment 1.

FIG. 5 is a cross-sectional view illustrating a peripheral configuration of a guide roller used in a washing method of Embodiment 2.

FIG. 6 is a cross-sectional view illustrating a peripheral configuration of a roller used in a washing method of Embodiment 3.

FIG. 7 is a cross-sectional view illustrating an example in which a position of a driving roller and a position of an auxiliary roller are changed in the washing device illustrated in FIG. 4.

FIG. 8 is a cross-sectional view schematically illustrating an example of a method for producing a polarizing film and a device for producing the polarizing film, in accordance with Embodiment 5.

FIG. 9 is a perspective view schematically illustrating a liquid removing member illustrated in FIG. 8.

FIG. 10 is a cross-sectional view perpendicular to a length direction of a glass plate which has been chamfered.

FIG. 11 is a cross-sectional view perpendicular to a length direction of a glass plate which has been chamfered.

FIG. 12 is a cross-sectional view illustrating an angle formed between the liquid removing member illustrated in FIG. 8 and a film.

FIG. 13 is a cross-sectional view illustrating an angle formed between a liquid removing member having another shape and a film.

### DESCRIPTION OF EMBODIMENTS

### Basic Configuration

The description below deals sequentially with a lithium-ion secondary battery, a separator, a heat-resistant separator, and a method for producing a heat-resistant separator.

### (Lithium Ion Secondary Battery)

A nonaqueous electrolyte secondary battery, typically, a lithium-ion secondary battery has a high energy density, and therefore, currently widely used not only as batteries for use in devices such as personal computers, mobile phones, and mobile information terminals, and for use in moving bodies such as automobiles and airplanes, but also as stationary batteries contributing to stable power supply.

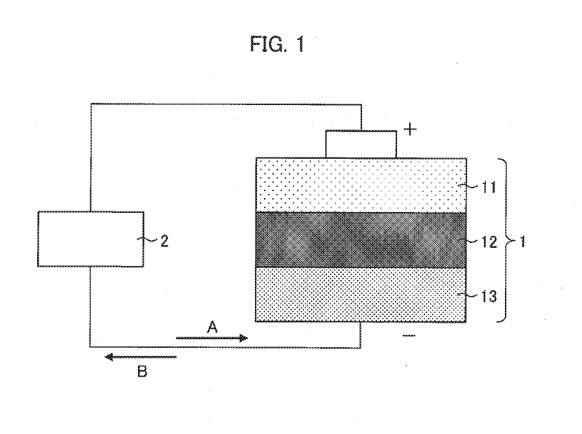

FIG. 1 is a diagram schematically illustrating a cross sectional configuration of a lithium-ion secondary battery 1.

As illustrated in FIG. 1, the lithium-ion secondary battery 1 includes a cathode 11, a separator 12, and an anode 13. Between the cathode 11 and the anode 13, an external device 2 is connected outside the lithium-ion secondary battery 1. Then, while the lithium-ion secondary battery 1 is being charged, electrons move in a direction A. On the other hand, while the lithium-ion secondary battery 1 is being discharged, electrons move in a direction B.

### (Separator)

The separator 12 is provided so as to be sandwiched between the cathode 11 which is a positive electrode of the lithium-ion secondary battery 1 and the anode 13 which is a negative electrode of the lithium-ion secondary battery 1. The separator 12 is a porous film which separates the cathode 11 and the anode 13, allowing lithium ions to move between the cathode 11 and the anode 13. The separator 12 contains, for example, polyolefin such as polyethylene or polypropylene as a material.

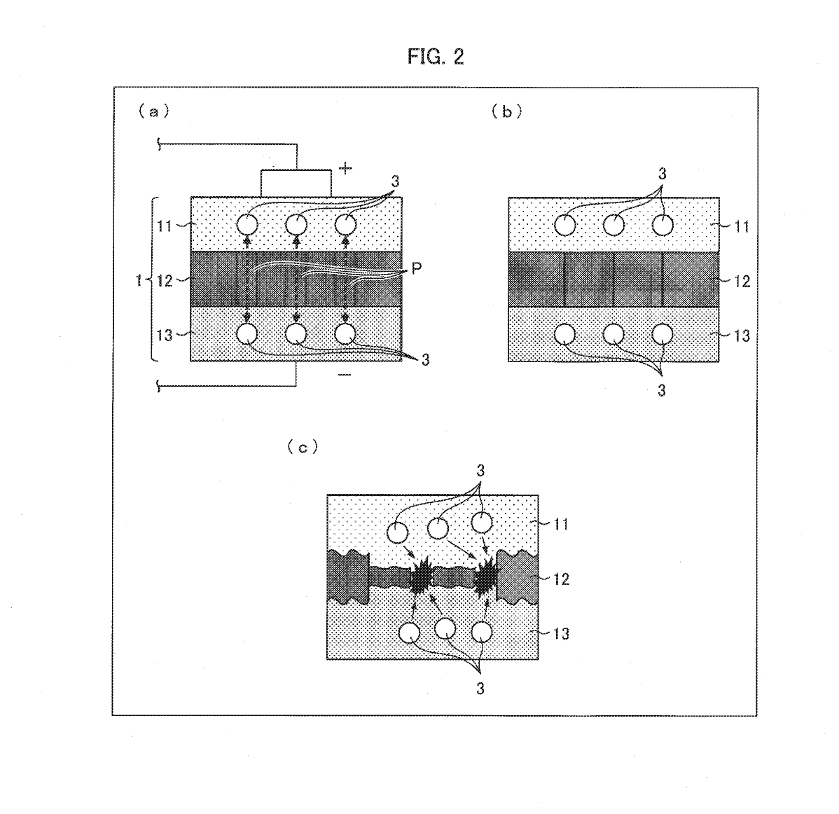

FIG. 2 provides diagrams each schematically illustrating details of the configuration of the lithium-ion secondary battery 1 illustrated in FIG. 1. (a) of FIG. 2 illustrates a normal configuration. (b) of FIG. 2 illustrates a state in which a temperature of the lithium-ion secondary battery 1 has risen. (c) of FIG. 2 illustrates a state in which a temperature of the lithium-ion secondary battery 1 has sharply risen.

As illustrated in (a) of FIG. 2, the separator 12 is provided with many pores P. Normally, lithium ions 3 in the lithium-ion secondary battery 1 can move back and forth through the pores P.

However, there are, for example, cases in which the temperature of the lithium-ion secondary battery 1 rises due to excessive charging of the lithium-ion secondary battery 1, a high current caused by short-circuiting of the external device, or the like. In such cases, the separator 12 melts or softens and the pores P are blocked as illustrated in (b) of FIG. 2. As a result, the separator 12 shrinks. This stops the movement of the lithium ions 3, and consequently stops the above temperature rise.

However, in a case where a temperature of the lithium-ion secondary battery 1 sharply rises, the separator 12 suddenly shrinks. In this case, as illustrated in (c) of FIG. 2, the separator 12 may be destroyed. Then, the lithium ions 3 leak out from the separator 12 which has been destroyed. As a result, the lithium ions 3 do not stop moving. Consequently, the temperature continues rising.

### (Heat-Resistant Separator)

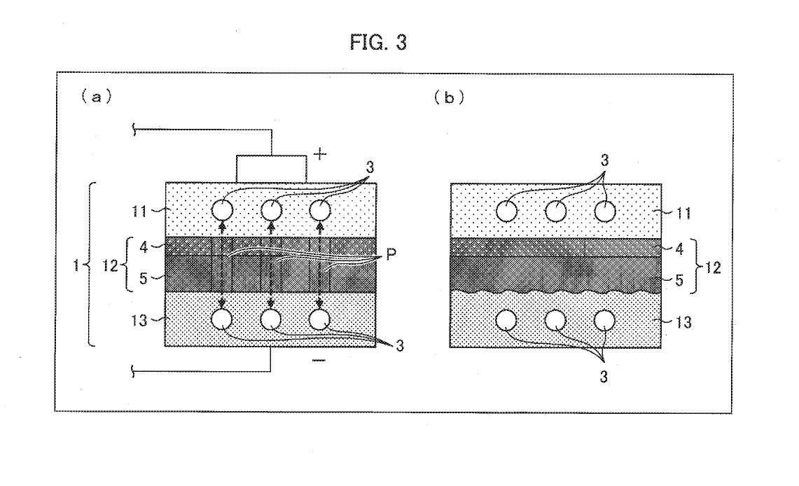

FIG. 3 provides diagrams schematically illustrating another configuration of the lithium-ion secondary battery 1 illustrated in FIG. 1. (a) of FIG. 3 illustrates a normal configuration, and (b) of FIG. 3 illustrates a state in which a temperature of the lithium-ion secondary battery 1 has sharply risen.

As illustrated in (a) of FIG. 3, the separator 12 can be a heat-resistant separator that includes a porous film 5 and a heat-resistant layer 4. The heat-resistant layer 4 is laminated on a surface of the porous film 5 which surface is on a cathode 11 side. Note that the heat-resistant layer 4 can alternatively be laminated on a surface of the porous film 5 which surface is on an anode 13 side, or both surfaces of the porous film 5. Further, the heat-resistant layer 4 is provided with pores which are similar to the pores P. Normally, the lithium ions 3 move back and forth through the pores P and the pores of the heat-resistant layer 4. The heat-resistant layer 4 contains, for example, wholly aromatic polyamide (aramid resin) as a material.

As illustrated in (b) of FIG. 3, even in a case where the temperature of the lithium-ion secondary battery 1 sharply rises and as a result, the porous film 5 melts or softens, the shape of the porous film 5 is maintained because the heat-resistant layer 4 supports the porous film 5. Therefore, such a sharp temperature rise results in only melting or softening of the porous film 5 and consequent blocking of the pores P. This stops movement of the lithium ions 3 and consequently stops the above-described excessive discharging or excessive charging. In this way, the separator 12 can be prevented from being destroyed.

### (Steps of Producing Separator, Heat-Resistant Separator)

How to produce the separator and heat-resistant separator of the lithium-ion secondary battery 1 is not specifically limited, and the separator and heat-resistant separator can be produced by a well-known method. The following discussion assumes a case where the porous film 5 contains polyethylene as a main material. However, even in a case where the porous film 5 contains another material, similar steps can still be applied to production of the separator 12 (heat-resistant separator).

For example, it is possible to employ a method including the steps of first forming a film by adding an inorganic filler or plasticizer to a thermoplastic resin, and then washing the film with an appropriate solvent to remove the inorganic filler or plasticizer. For example, in a case where the porous film 5 is a polyolefin separator made of a polyethylene resin containing ultrahigh molecular weight polyethylene, it is possible to produce the separator 12 by the following method.

This method includes (1) a kneading step of obtaining a polyethylene resin composition by kneading an ultrahigh molecular weight polyethylene and an inorganic filler (for example, calcium carbonate or silica) or plasticizer (for example, a low molecular weight polyolefin or liquid paraffin), (2) a rolling step of forming a film with the polyethylene resin composition, (3) a removal step of removing the inorganic filler or plasticizer from the film obtained in the step (2), and (4) a stretching step of obtaining the porous film 5 by stretching the film obtained in the step (3). The step (4) may alternatively be carried out between the steps (2) and (3).

In the removal step, many fine pores are provided in the film. The fine pores of the film stretched in the stretching step become the above-described pores P. The porous film 5 formed as a result is a polyethylene microporous film having a prescribed thickness and a prescribed air permeability (that is, a separator 12 not having a heat-resistant layer).

Note that in the kneading step, 100 parts by weight of the ultrahigh molecular weight polyethylene, 5 parts by weight to 200 parts by weight of a low-molecular weight polyolefin having a weight-average molecular weight of not more than 10000, and 100 parts by weight to 400 parts by weight of the inorganic filler can be kneaded.

Thereafter, in a coating step, the heat-resistant layer 4 is formed on a surface of the porous film 5. For example, on the porous film 5, an aramid/NMP (N-methylpyrrolidone) solution (coating solution) is applied (applying step) and solidified (solidifying step), and thereby, the heat-resistant layer 4 that is an aramid heat-resistant layer is formed. The heat-resistant layer 4 can be provided on only one surface or both surfaces of the porous film 5.

In the coating step, a polyvinylidene fluoride/dimethylacetamide solution (coating solution) may be applied (applying step) to a surface of the porous film 5 and solidified (solidifying step) to form an adhesive layer on the surface of the porous film 5. The adhesive layer can be provided on only one surface or both surfaces of the porous film 5.

In this specification, a layer, which has a function such as adhesiveness to an electrode or heat resistance to a temperature equal to or higher than a melting point of polyolefin, is referred to as “functional layer”.

A method for coating the porous film 5 with a coating solution is not specifically limited as long as uniform wet coating can be performed by the method. The method can be a conventionally well-known method such as a capillary coating method, a slit die coating method, a spray coating method, a dip coating method, a roll coating method, a screen printing method, a flexo printing method, a bar coater method, a gravure coater method, or a die coater method. The heat-resistant layer 4 has a thickness which can be controlled by adjusting a thickness of a coating wet film and/or a solid-content concentration in the coating solution.

It is possible to use a resin film, a metal belt, a drum or the like as a support with which the porous film 5 is fixed or transferred in coating.

As described above, it is possible to produce the separator 12 (heat-resistant separator) in which the heat-resistant layer 4 is laminated on the porous film 5. Thus produced separator is wound on a cylindrical core. Note that a subject to be produced by the above production method is not limited to the heat-resistant separator. The above production method does not necessarily include the coating step. In a case where the method includes no coating step, the subject to be produced is a separator having no heat-resistant layer.

### Embodiment 1

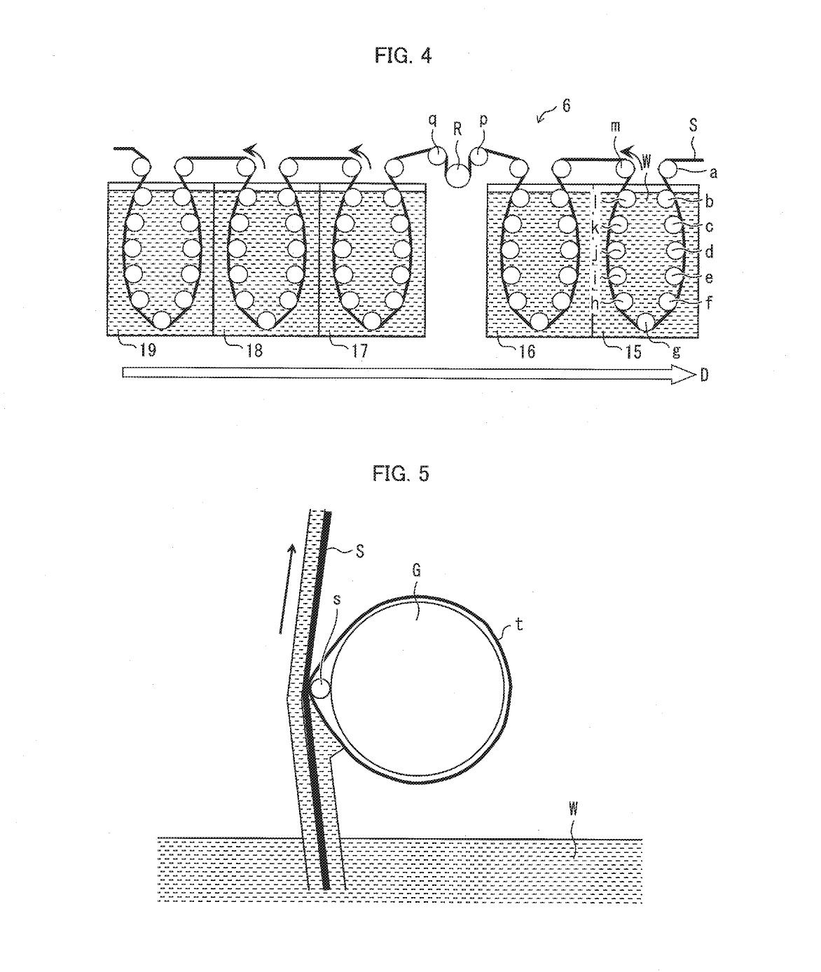

The following description will discuss Embodiment 1 of the present invention, with reference to FIG. 4.

In the following embodiment, a washing method for washing a heat-resistant separator, which is a long and porous battery separator, is described. A heat-resistant layer of the heat-resistant separator is formed by applying an aramid/NMP (N-methylpyrrolidone) solution (coating solution) to a porous film. In this case, NMP (remove-target substance) which is a solvent sinks into pores of the porous film.

An air permeability of the heat-resistant separator in which NMP remains in the pores is lower than that of a heat-resistant separator in which no NMP remains in pores. As the air permeability is lower, movement of lithium ions of a lithium-ion secondary battery including the heat-resistant separator is further interfered with, and consequently output of the lithium-ion secondary battery decreases. Therefore, it is preferable to wash the heat-resistant separator so that NMP does not remain in the pores of the heat-resistant separator.

### <<Configuration for Washing Heat-Resistant Separator>>

### (Washing Tank)

FIG. 4 is a cross-sectional view illustrating a configuration of a washing device 6 used in a washing method of the present embodiment.

As illustrated in FIG. 4, the washing device 6 includes washing tanks 15 through 19 (liquid tank). Each of the washing tanks 15 through 19 is filled with washing water W (washing liquid, liquid).

Further, the washing device 6 includes a plurality of rollers which are rotatable for transferring a heat-resistant separator S. Among the plurality of rollers, rollers a through m are rollers for transferring the heat-resistant separator S which is to be washed in the washing tank 15.

The heat-resistant separator S which has been transferred from a step (for example, coating step) which is upstream from a washing step passes through, via the rollers a through m, the washing water W (hereinafter referred to as “water”) filling the washing tank 15. The rollers a through m (transferring roller) define a transferring path of the heat-resistant separator S in the washing tank 15. In the washing tanks 16 through 19, the heat-resistant separator S is washed in a manner similar to that in the washing tank 15.

### (Driving Roller)

The washing device 6 further includes a driving roller R and auxiliary rollers p and q for applying driving force to the heat-resistant separator S between washing tanks. The auxiliary rollers p and q define an angle (so-called “holding angle”) at which the heat-resistant separator S makes contact with the driving roller R. Although the driving roller R and the auxiliary rollers p and q can be provided in the washing water W, the driving roller R and the auxiliary rollers p and q are preferably provided between washing tanks as illustrated in FIG. 4, because it is not necessary to give a water-proof treatment to the rollers.

As described above, driving force for transferring the heat-resistant separator S is applied between a position of the roller a for the washing tank 15 (first washing tank) and a position of a roller (corresponding to the roller m) for the washing tank 19 (second washing tank). Here, the “position of the roller a for the washing tank 15” is a position at which the heat-resistant separator S is brought into the washing tank 15. The “position of a roller (corresponding to the roller m) for the washing tank 19” is a position at which the heat-resistant separator S is taken out from the washing tank 19.

The driving force is preferably applied to the heat-resistant separator S between (i) a position which is of a roller (corresponding to the roller 1) for the washing tank 16 (first washing tank) and is on a washing tank 17 side and (ii) a position which is of a roller (corresponding to the roller b) for the washing tank 17 (second washing tank) and is on a washing tank 16 side. Here, the “position which is of a roller (corresponding to the roller 1) for the washing tank 16 and is on a washing tank 17 side” is a position at which the heat-resistant separator S is taken out from washing water W in the washing tank 16. The “position which is of a roller (corresponding to the roller b) for the washing tank 17 and is on a washing tank 16 side” is a position at which the heat-resistant separator S is brought into the washing water W in the washing tank 17.

### <<Operation for Washing Heat-Resistant Separator>>

The washing method of the present embodiment includes a step of transferring the heat-resistant separator S in a longitudinal direction of the heat-resistant separator S and a step of washing the heat-resistant separator S, which is being transferred, by causing the heat-resistant separator S to sequentially pass through washing waters W in the washing tanks 15 through 19. As such, the heat-resistant separator S is sequentially transferred from an upstream washing tank (first washing tank) to a downstream washing tank (second washing tank). Here, unless otherwise noted, the terms “upstream” and “downstream” respectively mean an upstream side and a downstream side in a transferring direction of a separator.

After washing in the washing tanks 15 through 19 has finished, the heat-resistant separator S is transferred to a step (for example, drying step) downstream from the washing step.

### Effect of Present Embodiment

### Washing by Diffusion

In a case where the heat-resistant separator S passes through the washing water W, NMP diffuses from the pores of the heat-resistant separator S to the water. Here, a diffusion amount of NMP becomes larger as a concentration of NMP in the washing water W is lower.

The heat-resistant separator S is washed sequentially in the washing tanks 15 through 19, and therefore a concentration of NMP in washing water W is lower in a downstream washing tank than in an upstream washing tank. That is, NMP is diffused in stages, and it is therefore possible to reliably remove NMP from the pores.

(Direction in which Washing Water Flows)

As illustrated in FIG. 4, washing water W can flow in a direction D from the downstream washing tank 19 to the upstream washing tank 15 in the separator transferring direction. From this, for example, partition walls each provided between the washing tanks 15 through 19 can have heights which become lower from the downstream side to the upstream side in the separator transferring direction. In this case, in the washing method of the present embodiment, washing water W is supplied to the downstream washing tank and the washing water W in the downstream washing tank is then supplied to an upstream washing tank, and thus the washing method further includes a step of renewing a washing liquid in each of the washing tanks. From the upstream washing tank 15, part of the washing water W flows out. With the configuration, it is possible to cause an NMP concentration in washing water W in the downstream washing tank in the separator transferring direction to be lower than an NMP concentration in washing water W in the upstream washing tank, while efficiently using the washing water W.

### (Efficient Washing)

By diffusing NMP in stages, it is possible to efficiently remove NMP, as compared with washing in only one washing tank. It is therefore possible to shorten a transferring distance of the heat-resistant separator S during washing. From this, it is possible to wash the heat-resistant separator S whose mechanical strength is lower than that of a non-porous film while inhibiting a fold and a tear.

### <<Other Configuration>>

### (Circulation of Washing Water)

As a width of the heat-resistant separator S becomes broader, productivity increases. Therefore, the width (i.e., a width in a direction perpendicular to the sheet on which FIG. 4 is illustrated) of the heat-resistant separator S is often set to be a width similar to that of the washing tanks 15 through 19. Moreover, the width of the washing tanks 15 through 19 is designed in accordance with the width of the heat-resistant separator S.

In a case where the width of the heat-resistant separator S is broadened and a gap between an edge of the heat-resistant separator S and the washing tanks 15 through 19 becomes smaller, washing water W in each of the washing tanks 15 through 19 is to be separated into one surface side (i.e., center side of washing tank) of the heat-resistant separator S and another surface side (i.e., both end sides of washing tank (right and left sides of washing tank in FIG. 4)) of the heat-resistant separator S.

In the washing in the washing tanks 15 through 19, the washing water W is often supplied/drained by overflow between the washing tanks 15 through 19. In this case, washing water W on the one surface side of the heat-resistant separator S may be supplied/drained, whereas washing water W on the another surface side of the heat-resistant separator S may remain.

In view of this, the washing method of the present embodiment can include a step of circulating washing water W so as to facilitate interchanging of washing waters W between the one surface side and the another surface side of the heat-resistant separator S in at least one of the washing tanks 15 through 19. In this case, the washing device 6 can further include a circulating device which is provided in the at least one of the washing tanks 15 through 19 and has an inlet and an outlet for washing water W.

This makes it possible to further uniformize an NMP concentration in washing water W in one washing tank, and it is therefore possible to facilitate efficient removal of NMP.

### (Washing Water)

The washing water W is not limited to water, provided that the washing water W is a washing liquid which can remove NMP from the heat-resistant separator S.

Moreover, the washing water W can contain a cleaning agent such as a surfactant, an acid (e.g., hydrochloric acid), or a base. A temperature of the washing water W is preferably 120° C. or lower. With this temperature condition, heat shrinkage of the heat-resistant separator S is less likely to occur. The temperature of the washing water W is more preferably 20° C. or higher and 100° C. or lower.

### (Method for Producing Polyolefin Separator)

The above washing method for washing the heat-resistant separator S is applicable to a washing method for washing a separator (polyolefin separator) having no heat-resistant layer.

The separator is formed by stretching a film-shaped polyolefin resin composition which has been obtained by kneading high molecular weight polyolefin such as ultrahigh molecular weight polyethylene and an inorganic filler or a plasticizer. Further, the remove-target substance such as the inorganic filler or the plasticizer is washed, and thus pores of the separator are formed.

An air permeability of a separator in which the remove-target substance has not been washed and remains in pores is lower than an air permeability of a separator in which the remove-target substance does not remain in pores. As the air permeability is lower, movement of lithium ions of a lithium-ion secondary battery including a separator is further interfered with, and consequently output of the lithium-ion secondary battery decreases. Therefore, it is preferable to wash the separator so that the remove-target substance does not remain in the pores of the separator.

A washing liquid for washing a separator containing an inorganic filler is not limited, provided that the washing liquid can remove the inorganic filler from the separator. The washing liquid is preferably an aqueous solution containing an acid or a base.

A washing liquid for washing a separator containing a plasticizer is not limited, provided that the washing liquid can remove the plasticizer from the separator. The washing liquid is preferably an organic solvent such as dichloromethane.

The outline of the above is as follows: that is, the washing method for washing a film-shaped polyolefin resin composition (film) includes the steps of (i) transferring a film, which is long and is an intermediate product of the separator, in a longitudinal direction of the film and (ii) washing the film by causing the film, which is being transferred, to sequentially pass through washing liquids in the respective washing tanks 15 through 19.

As such, in FIG. 4, the heat-resistant separator S can serve as a film which is an intermediate product of a separator. Moreover, the washing water W can be an aqueous solution which contains an acid or a base.

The method for producing a polyolefin separator includes (i) a forming step of forming a film which is long, is an intermediate product of a long and porous separator, and contains polyolefin as a main component and (ii) the steps of the above film washing method which steps are carried out after the forming step.

### (Method for Producing Laminated Separator)

The present invention encompasses a method for producing a heat-resistant separator S, which is a laminated separator, with use of the washing method for washing the heat-resistant separator S. Here, the heat-resistant separator S is a laminated separator including a porous film 5 (base material, first layer) and a heat-resistant layer 4 (functional layer, second layer) which is laminated on the porous film 5, as illustrated in FIG. 3. Note that the heat-resistant layer 4 is thinner than a base material layer. This producing method includes a forming step of forming a long and porous heat-resistant separator S and the steps in the above described separator washing method which steps are carried out after the forming step.

In order to laminate the heat-resistant layer 4, the “forming step” includes an applying step of applying, to the porous film 5, NMP (liquid substance) containing aramid resin (substance) for constituting the heat-resistant layer 4 and a solidifying step of solidifying the aramid resin after the applying step.

The “steps” mean the steps of (i) transferring the heat-resistant separator S in the longitudinal direction thereof and (ii) washing the heat-resistant separator S by causing the heat-resistant separator S, which is being transferred, to sequentially pass through washing waters W in the respective washing tanks 15 through 19.

From this, it is possible to produce the laminated separator which hardly contains NMP and in which a fold and a tear are inhibited. Note that the heat-resistant layer can be the early described adhesive layer.

### Embodiment 2

The following description will discuss Embodiment 2 of the present invention with reference to FIG. 5. For convenience of explanation, identical reference numerals are given to constituent members having functions identical with those of the constituent members described in Embodiment 1, and descriptions of such constituent members are omitted here. This applies to other embodiments described below.

### <<Other Configuration for Washing Heat-Resistant Separator>>

FIG. 5 is a cross-sectional view illustrating a peripheral configuration of a guide roller G used in a washing method of the present embodiment.

As illustrated in FIG. 5, a washing device 6 further includes a guide roller G, a Teflon bar s, and a Teflon tube t. Note that “Teflon” is a registered trademark.

The guide roller G (i) is fixed to a transferring path on which the heat-resistant separator S is transferred, (ii) does not rotate, and (iii) is provided between rollers 1 and m for a washing tank 15. An axis of the guide roller G extends in a depth direction of FIG. 5 and is in parallel with the heat-resistant separator S.

The Teflon bar s (bar-like member) extends in an axis direction of the guide roller G and is provided on a surface of the guide roller G. The Teflon bar s which is thus provided on the surface of the guide roller G is fixed by the Teflon tube t so as to be located between the guide roller G and the heat-resistant separator S.

The Teflon tube t (sheet-like member) covers (wraps) the guide roller G and the Teflon bar s so as to bind up the guide roller G and the Teflon bar s. The Teflon tube t contains synthetic resin as a main component (for example, fluorine resin).

Note that the guide roller G can be provided for any of the washing tanks 16 through 19. Moreover, the washing device 6 can include plural sets of the guide roller G, the Teflon bar s, and the Teflon tube t.

### <<Operation for Washing Heat-Resistant Separator>>

The washing method of the present embodiment includes, in addition to the steps in the washing method of Embodiment 1, the step of removing washing water W from the heat-resistant separator S between an upstream washing tank and a downstream washing tank.

In a case where the heat-resistant separator S is pulled up from the water, part of washing water W in the upstream washing tank is brought to the downstream washing tank along the surface of the heat-resistant separator S. In view of this, the washing water W which is to be brought to the downstream washing tank is scraped off from the heat-resistant separator S.

The Teflon bar s which is provided on the surface of the guide roller G that is fixed serves to form a protrusion (first member) on a surface of the Teflon tube t. The protrusion is brought into contact with the heat-resistant separator S so as to softly rub the heat-resistant separator S, slides with respect to the heat-resistant separator S, and thus scrapes washing water W off from the heat-resistant separator S.

### Effect of Present Embodiment

With the configuration of the present embodiment, it is possible to reduce washing water W which is to be brought from the upstream washing tank to the downstream washing tank. It is therefore possible to reliably control an NMP concentration in washing water W in the downstream washing tank to be lower than that in washing water W in the upstream washing tank. This leads to reliable removal of NMP from the pores of the heat-resistant separator S.

### (Others)

The Teflon tube t does not absorb washing water W, that is, the Teflon tube t is a non-water-absorbing member. Here, if a member which slides with respect to the heat-resistant separator S has a water-absorbing property, washing water W is to be continuously absorbed by the member. In such a case, it is necessary to provide a mechanism for removing washing water W thus absorbed. For example, a sponge roller is used as the member, and a suction pump is used as the removing mechanism.

However, the sponge roller lacks durability. Moreover, the suction pump continuously consumes energy. As such, the water-absorbing member is not suitable for continuously removing water from the heat-resistant separator S.

On the other hand, according to the film producing method of the present embodiment, it is not necessary to provide such a mechanism. Therefore, it is possible to continuously remove washing water W from the heat-resistant separator S. This makes it possible to produce the heat-resistant separator S from which washing water W used in the washing treatment has been sufficiently removed.

The heat-resistant separator S and a pressing member (in the above example, the protrusion on the surface of the Teflon tube t) to be pressed against the heat-resistant separator S are configured to move at relatively different speeds. Moreover, in a case where the guide roller G is configured to rotate, it is only necessary to configure the heat-resistant separator S and the pressing member so as not to move at the same speed, regardless of a direction in which the guide roller G rotates.

In a water removing member (first member) including the guide roller G, the Teflon bar s, and the Teflon tube t, it is possible to change a shape of a part, which slides with respect to the heat-resistant separator S, by replacing the Teflon bar s with a bar having a different shape. From this, it is possible to change force which is to be applied to the heat-resistant separator S when washing water W is removed from the heat-resistant separator S.

Note that, as described below, it is possible to remove liquid from the heat-resistant separator S by causing a plate-like liquid removing member to slide with respect to the heat-resistant separator S.

In a case where the heat-resistant separator S is a polyethylene porous film which has one surface coated with a heat-resistant aramid layer, it is preferable to press the protrusion formed on the surface of the Teflon tube t against another surface of the porous film which another surface is not coated with the heat-resistant layer. That is, it is preferable that the protrusion is provided on a side opposite to the heat-resistant layer of the heat-resistant separator S, and no protrusion is provided on a heat-resistant layer side of the heat-resistant separator S. With the configuration, it is possible to remove washing water W from the heat-resistant separator S while preventing damage on the heat-resistant layer. This makes it possible to prevent detachment of the heat-resistant layer.

In other words, in a case where the heat-resistant separator S is a film having a first layer and a second layer which is thinner than the first layer (or is more likely to abrade than the first layer, or is more fragile than the first layer, or is formed later than the first layer), it is preferable to provide the Teflon tube t and the like on a first layer side of the heat-resistant separator S and preferable not to provide a member which slides with respect to the heat-resistant separator S.

### Embodiment 3

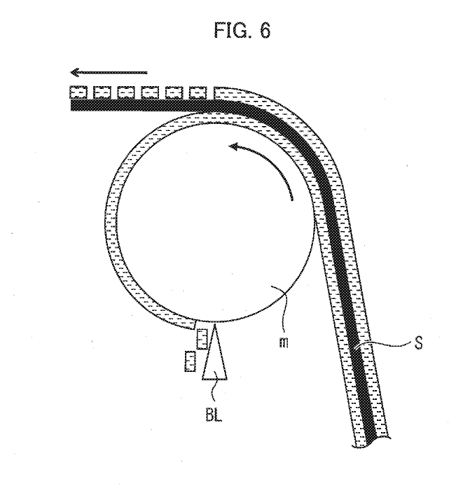

The following description will discuss Embodiment 3 of the present invention with reference to FIG. 6.

### <<Other Configuration for Washing Heat-Resistant Separator>>

FIG. 6 is a cross-sectional view illustrating a peripheral configuration of a roller m (transferring roller) used in a washing method of the present embodiment. As illustrated in FIG. 6, a washing device 6 further includes a scrape-off bar BL (second member).

The scrape-off bar BL is a blade for scraping off washing water W which is transferred along the roller m.

A slight gap is provided between the roller m and the scrape-off bar BL. With the configuration, the washing water W adhering to the roller m moves to the scrape-off bar BL while damage on a surface of the roller m and abrasion of the scrape-off bar BL are prevented.

### <<Operation for Washing Heat-Resistant Separator>>

The washing method of the present embodiment includes, in addition to the steps in the washing method of Embodiment 1, the step of removing washing water W from the roller m for transferring the heat-resistant separator S between an upstream washing tank and a downstream washing tank.

When the heat-resistant separator S is transferred, part of washing water W is brought to the downstream washing tank along a surface of the heat-resistant separator S. Further, the part of washing water W which is brought to the downstream washing tank is transferred along the roller m. Then, the washing water W transferred along the roller m is scraped off from the roller m.

### Effect of Present Embodiment

With the configuration of the present embodiment, it is possible to reduce an amount of washing water W which is brought from the upstream washing tank to the downstream washing tank. It is therefore possible to reliably control an NMP concentration in washing water W in the downstream washing tank to be lower than that in washing water W in the upstream washing tank. This leads to reliable removal of NMP from the pores of the heat-resistant separator S.

### (Others)

A size of the gap provided between the roller m and the scrape-off bar BL is approximately 1 mm. Note, however, that, in a case where a larger amount of washing water W accumulates on the surface of the roller m, the above effect can be brought about with a size of the gap larger than 1 mm. The size of the gap depends on viscosity of washing water W, rotation speed of the roller m, and the like.

In a case where no gap is provided between the roller m and the scrape-off bar BL, at least one of the roller m and the scrape-off bar BL preferably contains synthetic resin as a main component. Note that it is more preferable that both the roller m and the scrape-off bar BL contain synthetic resin as a main component.

An angle of the scrape-off bar BL with respect to the roller m is 90° in the above described example. Note, however, that the angle is not limited to this and can be, for example, an acute angle.

### [Variation 1]

The washing device 6 can include all the guide roller G, the Teflon bar s, the Teflon tube t (which are illustrated in FIG. 5), and the scrape-off bar BL (which is illustrated in FIG. 6).

A washing method of this variation includes, in addition to the steps in the washing method of Embodiment 1, the steps of removing washing water W from the heat-resistant separator S between the upstream washing tank and the downstream washing tank and removing washing water W from the roller m for transferring the heat-resistant separator S between the upstream washing tank and the downstream washing tank.

With the configuration, it is possible to further reduce an amount of washing water W which is brought from the upstream washing tank to the downstream washing tank. It is therefore possible to reliably control an NMP concentration in washing water W in the downstream washing tank to be lower than that in washing water W in the upstream washing tank. This leads to further reliable removal of NMP from the pores of the heat-resistant separator S.

### [Variation 2]

The washing device 6 can include one washing tank. From this, the present invention encompasses the following aspect:

A separator washing method in accordance with a first aspect of the present invention is a method for washing a battery separator which is long and porous, the separator washing method including the steps of: transferring the battery separator in a longitudinal direction of the battery separator; washing the battery separator by causing the battery separator, which is being transferred, to pass through a washing liquid in a washing tank; and removing the washing liquid from the battery separator between a position at which the battery separator is brought into the washing tank and a position at which the battery separator is taken out from the washing tank.

The first aspect is an aspect in which, for example, washing water W is removed from the heat-resistant separator S (battery separator) by the guide roller G, the Teflon bar s, and the Teflon tube t as illustrated in FIG. 5, in at least one of the washing tanks 15 through 19 which are illustrated in FIG. 4. According to the first aspect, it is possible to reduce an amount of the washing liquid which is to be brought from the washing step to another step.

A separator washing method in accordance with a second aspect of the present invention is a method for washing a battery separator which is long and porous, the separator washing method including the steps of: transferring the battery separator in a longitudinal direction of the battery separator; washing the battery separator by causing the battery separator, which is being transferred, to pass through a washing liquid in a washing tank; and removing the washing liquid from a transferring roller for transferring the battery separator between a position at which the battery separator is brought into the washing tank and a position at which the battery separator is taken out from the washing tank.

The second aspect is an aspect in which, for example, washing water W is removed from the roller m (transferring roller) for transferring the heat-resistant separator S (battery separator) by the scrape-off bar BL as illustrated in FIG. 6, in at least one of the washing tanks 15 through 19 which are illustrated in FIG. 4. According to the second aspect, it is possible to reduce an amount of the washing liquid which is to be brought from the washing step to another step.

A separator washing method in accordance with a third aspect of the present invention is a method for washing a battery separator which is long and porous, the separator washing method including the steps of: transferring the battery separator in a longitudinal direction of the battery separator; washing the battery separator by causing the battery separator, which is being transferred, to pass through a washing liquid in a washing tank; and circulating the washing liquid in the washing tank so as to facilitate interchanging of washing liquids between one surface side and another surface side of the battery separator.

The third aspect is an aspect in which, for example, washing water W (washing liquid) is circulated so as to facilitate interchanging of washing waters W between the one surface side and another surface side of the heat-resistant separator S (battery separator) in at least one of the washing tanks 15 through 19 which are illustrated in FIG. 4. According to the third aspect, it is possible to further uniformize a concentration of the remove-target substance in the washing liquid in the washing tank, and it is therefore possible to facilitate efficient removal of the remove-target substance.

A separator washing method in accordance with a fourth aspect of the present invention is a method for washing a battery separator which is long and porous, the separator washing method including the steps of: transferring the battery separator in a longitudinal direction of the battery separator; and washing the battery separator by causing the battery separator, which is being transferred, to pass through a washing liquid in a washing tank, in the transferring step, driving force for transfer is applied to the battery separator between a position at which the battery separator is brought into the washing tank and a position at which the battery separator is taken out from the washing tank.

The fourth aspect is an aspect in which, for example, driving force for transfer is applied to the heat-resistant separator S (battery separator) by the driving roller R between a position at which the heat-resistant separator S is brought into the washing tank and a position at which the heat-resistant separator S is taken out from the washing tank which is at least one of the washing tanks 15 through 19 which are illustrated in FIG. 4. According to the fourth aspect, force applied to the battery separator is dispersed, as compared with a case where the battery separator is pulled merely from a location downstream from the part at which the washing step is carried out. As a result, it is possible to inhibit a problem such as cutoff of the battery separator.

Note that, in a case where a mechanism for applying driving force to the battery separator is provided in the washing liquid, the position at which the battery separator is brought into the washing tank can be a position at which the battery separator is brought into the washing water in the washing tank and the position at which the battery separator is taken out from the washing tank can be a position at which the battery separator is taken out from the washing water in the washing tank.

A separator producing method in accordance with a fifth aspect of the present invention includes: a forming step of forming a long and porous battery separator; and steps in the separator washing method in accordance with any one of the first through fourth aspects, the steps in the separator washing method being carried out after the forming step.

In the fifth aspect, for example, a heat-resistant separator S (battery separator) including a porous film 5 and a heat-resistant layer 4 laminated on the porous film 5 (see FIG. 3) are formed, and then the heat-resistant separator S is washed in at least one of the washing tanks 15 through 19 illustrated in FIG. 4. According to the fifth aspect, it is possible to produce the battery separator in which a fold and a tear are inhibited and which has an air permeability higher than that of a conventional battery separator.

According to a separator producing method in accordance with a sixth aspect of the present invention, it is possible in the fifth aspect that the battery separator is a laminated separator including a base material and a functional layer laminated on the base material; and the forming step includes (i) an applying step of applying a liquid substance containing a substance for constituting the functional layer to the base material so as to laminate the functional layer and (ii) a solidifying step of solidifying the substance after the applying step.

In the sixth aspect, for example, in order to laminate a heat-resistant layer 4 (functional layer) on a porous film 5 (base material) as illustrated in FIG. 3, NMP (liquid substance) containing aramid resin (substance) for constituting the heat-resistant layer 4 is applied to the porous film 5, the aramid resin is solidified, and the heat-resistant separator S is washed in at least one of the washing tanks 15 through 19 illustrated in FIG. 4. According to the sixth aspect, it is possible to produce the laminated separator in which a fold and a tear are inhibited and which has an air permeability higher than that of a conventional laminated separator.

A separator washing method in accordance with a seventh aspect of the present invention includes, in a film washing method for obtaining a long and porous battery separator, the steps of: transferring a film which is long and is an intermediate product of the battery separator in a longitudinal direction of the film; and washing the film by causing the film, which is being transferred, to pass through a washing liquid in a washing tank, the film containing polyolefin as a main component.

In the seventh aspect, for example, a polyolefin resin composition obtained by kneading polyolefin and an inorganic filler or a plasticizer is formed into a film, and this film is stretched to be an intermediate product of a heat-resistant separator S (battery separator). Then, the intermediate product is washed in at least one of the washing tanks 15 through 19 illustrated in FIG. 4, and thus the inorganic filler or the plasticizer is washed away. According to the seventh aspect, it is possible to obtain the polyolefin separator in which a fold and a tear are inhibited and which has an air permeability higher than that of a conventional polyolefin separator.

A separator washing method in accordance with an eighth aspect of the present invention includes: a forming step of forming a film which is long and is an intermediate product of a long and porous battery separator; a transferring step of transferring the film in a longitudinal direction of the film; and a washing step of washing the film by causing the film, which is being transferred, to pass through a washing liquid in a washing tank, the transferring step and the washing step being carried out after the forming step.

In the eighth aspect, for example, a polyolefin resin composition obtained by kneading polyolefin and an inorganic filler or a plasticizer is formed into a film, and this film is stretched to be an intermediate product of a heat-resistant separator S (battery separator). Then, the intermediate product is washed in at least one of the washing tanks 15 through 19 illustrated in FIG. 4. According to the eighth aspect, it is possible to produce the battery separator in which a fold and a tear are inhibited and which has an air permeability higher than that of a conventional battery separator.

### [Variation 3]

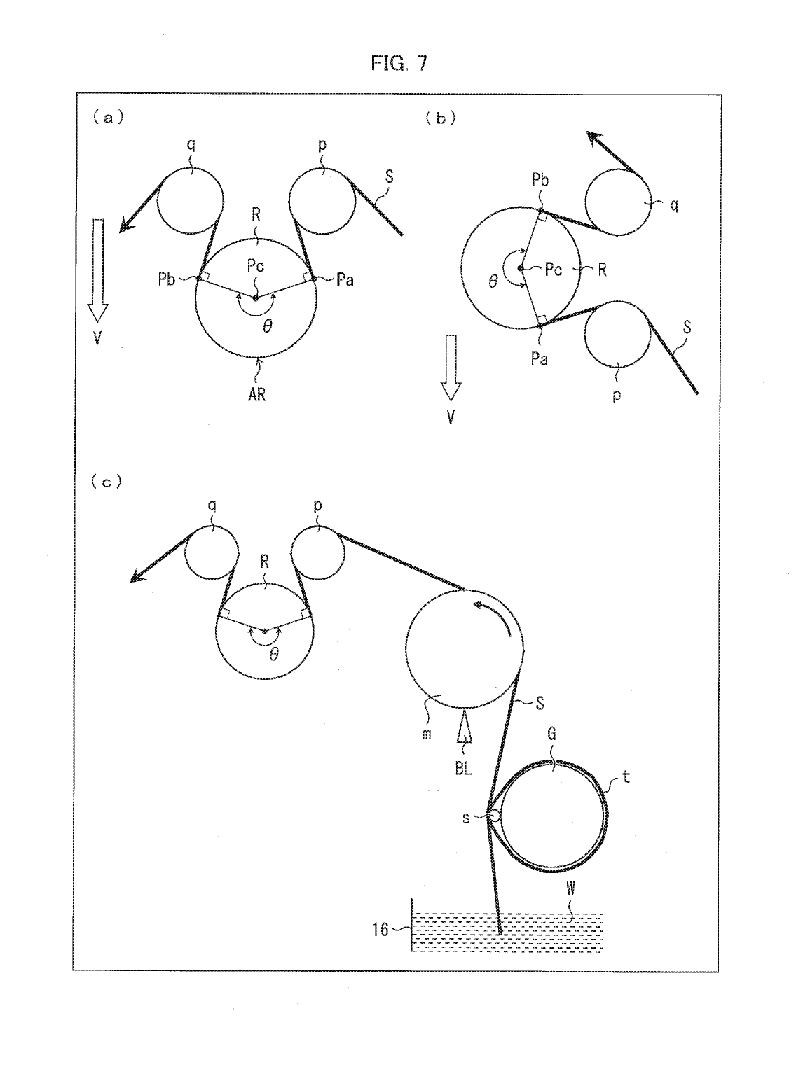

FIG. 7 is a cross-sectional view illustrating an example in which a position of the driving roller R and positions of the auxiliary rollers p and q are changed in the washing device 6 illustrated in FIG. 4. (a) of FIG. 7 illustrates a configuration in which the driving roller R is provided at a lower position than the auxiliary rollers p and q, (b) of FIG. 7 illustrates a configuration in which the driving roller R is provided at a lower position than the auxiliary roller q and at a higher position than the auxiliary roller p, and (c) of FIG. 7 illustrates a configuration in which a plurality of removing steps are combined. In FIG. 7, the arrow V indicates a vertically downward direction.

In (a) of FIG. 7, a center Pc is a point at which the rotation axis of the driving roller R is located. A point Pa indicates a position at which the heat-resistant separator S, which has been transferred from the auxiliary roller p, starts to make contact with the driving roller R. A point Pb indicates a position at which the heat-resistant separator S starts to leave from the driving roller R so as to be transferred to the auxiliary roller q.

The driving roller R is pressed against the heat-resistant separator S so as to apply transferring force to the heat-resistant separator S. In a cross section of the driving roller R, an arc AR which is a surface of the driving roller R and is making contact with the heat-resistant separator S has a holding angle θ which is 180° or larger. Note that the holding angle θ is an angle which is formed at the center Pc (i.e., the rotation axis of the driving roller R).

As illustrated in FIG. 4, the heat-resistant separator S is pulled up from washing water W in the washing tank 16 and is then transferred to the auxiliary roller p. In this case, washing water W is adhering to the surface of the heat-resistant separator S. Part of washing water W which is adhering to a surface of the heat-resistant separator S on an auxiliary roller p side is removed when the part of washing water W makes contact with the auxiliary roller p. Meanwhile, washing water W which is adhering to a surface of the heat-resistant separator S on an opposite side of the auxiliary roller p side is transferred to the driving roller R.

Part of washing water W which is adhering to a surface of the heat-resistant separator S on a driving roller R side is removed when the part of washing water W makes contact with the driving roller R. Specifically, the part of washing water W adhering to the driving roller R is extruded in a depth direction of (a) of FIG. 7, i.e., in the rotation axis direction of the driving roller R. Then, the washing water W which has moved to an edge of the heat-resistant separator S falls in the vertically downward direction. Moreover, another part of the washing water W adhering to the driving roller R penetrates through the heat-resistant separator S and then falls in the vertically downward direction.

In this case, as the holding angle θ increases, a contact area between the driving roller R and the heat-resistant separator S increases. From this, a contact area between the driving roller R and washing water W adhering to the surface of the heat-resistant separator S also increases, and therefore an amount of washing water W to be removed from the surface of the heat-resistant separator S increases as the holding angle θ becomes larger.

The holding angle θ of the driving roller R with respect to the heat-resistant separator S is preferably 120° or larger, more preferably 150° or larger, further preferably 180° or larger.

In a case where the holding angle θ of the driving roller R with respect to the heat-resistant separator S is 120° or larger, it is possible to increase frictional force between the heat-resistant separator S and the driving roller R, and it is therefore possible to prevent slip of the heat-resistant separator S on the driving roller R. Further, the heat-resistant separator S is closely brought into contact with the driving roller R, and therefore washing water W is removed from the interface between the heat-resistant separator S and the driving roller R.

In particular, in a case where the holding angle θ is 180° or larger, the driving roller R is sandwiched by the heat-resistant separator S whose direction is changed, and this makes it possible to further increase frictional force between the heat-resistant separator S and the driving roller R. As described above, it is possible to remove washing water W from the heat-resistant separator S while applying transferring force to the heat-resistant separator S.

In a case where the heat-resistant separator S has been prepared by coating one surface of a polyethylene porous film with a heat-resistant aramid layer, it is preferable that the driving roller R is provided on a side of the heat-resistant separator S opposite to the heat-resistant layer and the driving roller R is not provided on a heat-resistant layer side of the heat-resistant separator S. With the arrangement, it is possible to remove washing water W from the heat-resistant separator S without causing damage on the heat-resistant layer.

As illustrated in (b) of FIG. 7, the driving roller R can be provided at a lower position than the auxiliary roller q and at a higher position than the auxiliary roller p. In this case also, it is possible to remove washing water W from the heat-resistant separator S while applying transferring force to the heat-resistant separator S. As such, a positional relation of the driving roller R and the auxiliary rollers p and q is not limited to the arrangements illustrated in (a) and (b) of FIG. 7.

### (Combination of Removing Steps)

As illustrated in (c) of FIG. 7, it is possible to combine at least two of the first removing step illustrated in FIG. 5, the second removing step illustrated in FIG. 6, and the driving step illustrated in (a) of FIG. 7.

The first removing step is a step of removing washing water W from the heat-resistant separator S by sliding the water removing member (first member), which includes the guide roller G, the Teflon bar s, and the Teflon tube t, with respect to the heat-resistant separator S which has been taken out from the washing water W.

The second removing step is a step of removing washing water W from the roller m (transferring roller) which is provided for transferring the heat-resistant separator S, which has been taken out from the washing water W in the washing tank 15, to the washing step of washing the heat-resistant separator S by causing the heat-resistant separator S to pass through washing water W in the washing tank 16.

The driving step is a step of pressing the driving roller R against the heat-resistant separator S which has been taken out from washing water W after the washing step of washing the heat-resistant separator S by causing the heat-resistant separator S to pass through the washing water W in the washing tank 16 and before a drying treatment or another washing treatment. In the driving step, the holding angle θ of the driving roller R with respect to the heat-resistant separator S is 180° or larger.

(Position at which Removing Step is Carried Out)

As illustrated in FIG. 4, the heat-resistant separator S which has been subjected to the washing treatment in the washing tank 16 is transferred to the washing tank 17. In this case, the first removing step, the second removing step, and the driving step are carried out on a transferring path which is from a position at which the heat-resistant separator S is taken out from the washing water W in the washing tank 16 to a position at which the heat-resistant separator S is brought into washing water W in the washing tank 17.

The first removing step, the second removing step, and the driving step can be carried out for each of the washing tanks 15 and 17 through 19. In particular, in a case where the first removing step, the second removing step, and the driving step are carried out for the washing tank 19, the first removing step, the second removing step, and the driving step are carried out on a transferring path which is from a position at which the heat-resistant separator S is taken out from the washing water W in the washing tank 19 to a position from which the heat-resistant separator S is transferred to a treatment (for example, drying treatment) downstream from the washing treatment. That is, the first removing step, the second removing step, and the driving step are carried out before another treatment for processing (i.e., making a change to) the heat-resistant separator S.

### Embodiment 4

### Object

A porous separator and an intermediate product film of the porous separator are lower in mechanical strength than a simple non-porous film. Therefore, the porous separator and the intermediate product film are more likely to fold or tear while being washed. In a case where the washing is insufficient, an air permeability of the porous separator decreases. Patent Literatures 1 and 2 are silent about using a plurality of washing tanks for washing such a porous separator or an intermediate product film thereof.

In view of the above described characteristics of the separator, an object of the present embodiment is to provide a washing method suitable for a separator and an intermediate product film thereof and a method for producing a separator with use of the washing method.

### (Means)

A separator washing method of the present invention is a method for washing a battery separator which is long and porous, and the separator washing method includes the steps of: transferring the battery separator in a longitudinal direction of the battery separator; and washing the battery separator by causing the battery separator, which is being transferred, to sequentially pass through a washing liquid in a first washing tank and a washing liquid in a second washing tank.

By causing the separator to sequentially pass through plural stages of washing liquids, a remove-target substance diffuses from the separator to the washing liquids in the respective stages. A diffusion amount of the remove-target substance becomes larger as a concentration of the remove-target substance in the washing liquid is lower.

According to the method, it is possible to control a concentration of the remove-target substance in the washing liquid in the second washing tank to be lower than a concentration of the remove-target substance in the washing liquid in the first washing tank. This makes it possible to diffuse the remove-target substance in stages.

As a result, it is possible to remove the remove-target substance from the separator more efficiently than washing in only one washing tank. From this, it is possible to shorten a transferring distance of the separator which is being washed. This makes it possible to wash a porous separator whose mechanical strength is lower than a non-porous film while inhibiting a fold and a tear. As such, it is possible to carry out sufficient washing, and it is therefore possible to obtain a battery separator having an air permeability higher than that of a conventional battery separator.

The separator washing method of the present invention can further include the step of renewing washing liquids in the first washing tank and the second washing tank by supplying a washing liquid to the second washing tank and supplying the washing liquid of the second washing tank to the first washing tank.

According to the method, it is possible to cause the concentration of the remove-target substance in the washing liquid in the second washing tank to be lower than the concentration of the remove-target substance of the washing liquid in the first washing tank, while efficiently using the washing liquid.

In the separator washing method of the present invention, the concentration of the remove-target substance diffused from the battery separator to the washing liquid in the second washing tank is preferably lower than the concentration of the remove-target substance diffused from the battery separator to the washing liquid in the first washing tank.

In the washing method of Patent Literatures 1 and 2, the concentration of the remove-target substance in the washing liquid is not considered, and diffusion of the remove-target substance does not necessarily occur in stages.

According to the method of the present invention, it is possible to reliably diffuse the remove-target substance in stages.

The separator washing method of the present invention can further include the step of removing the washing liquid from the battery separator between the first washing tank and the second washing tank.

The separator washing method of the present invention can further include the step of removing the washing liquid from a transferring roller for transferring the battery separator between the first washing tank and the second washing tank.

According to the method, an amount of the washing liquid which is to be brought from the first washing tank to the second washing tank is reduced. This makes it possible to control the concentration of the remove-target substance in the washing liquid in the second washing tank to be lower than the concentration of the remove-target substance in the washing liquid in the first washing tank. Therefore, it is possible to efficiently remove the remove-target substance from the battery separator.

The separator washing method of the present invention can further include the step of circulating the washing liquid in order to facilitate interchanging of washing liquids between one surface side and another surface side of the battery separator in at least one of the first washing tank and the second washing tank.

In each of the first and second washing tanks, the passing battery separator serves as a partition wall and the washing liquid hardly interchanges between one surface side and another surface side of the battery separator. This causes the concentration of the remove-target substance in the washing liquid to be higher on the one surface side or the another surface side of the battery separator than the other side. As a result, this may interfere with efficient removal of the remove-target substance.

According to the method, the washing liquid is circulated so that interchanging of washing liquids between the one surface side and the another surface side of the battery separator is facilitated, and this makes it possible to further uniformize the concentration of the remove-target substance in the washing liquid and accordingly it is possible to facilitate efficient removal of the remove-target substance.

In the separator washing method of the present invention, in the step of transferring the battery separator in a longitudinal direction of the battery separator, driving force for transferring the battery separator can be applied to the battery separator between a position at which the battery separator is brought into the first washing tank and a position at which the battery separator is taken out from the second washing tank.

According to the method, force applied to the battery separator is dispersed, as compared with a case where the battery separator is pulled only from a stage which is downstream from the second washing tank. As a result, it is possible to prevent a problem such as cutoff of the battery separator.

In the separator washing method of the present invention, the driving force can be applied to the battery separator between a position at which the battery separator is taken out from the washing liquid in the first washing tank and a position at which the battery separator is brought into the washing liquid in the second washing tank.

According to the method, a mechanism for applying driving force to the battery separator can be provided between the first washing tank and the second washing tank, and it is therefore unnecessary to subject the mechanism to a water-proof treatment.

A separator producing method of the present invention includes a forming step of forming a long and porous battery separator and the steps in the above described separator washing method, the steps in the separator washing method being carried out after the forming step.

According to the method, it is possible to produce a battery separator in which a fold and a tear are inhibited and which has an air permeability higher than that of a conventional battery separator.

In the separator producing method of the present invention, it is possible that the battery separator is a laminated separator including a base material and a functional layer laminated on the base material; and the forming step includes (i) an applying step of applying a liquid substance containing a substance for constituting the functional layer to the base material so as to laminate the functional layer and (ii) a solidifying step of solidifying the substance after the applying step.

According to the method, it is possible to produce the laminated separator in which a fold and a tear are inhibited and which has an air permeability higher than that of a conventional laminated separator.

The film washing method of the present invention is a method for obtaining a battery separator which is long and porous, and the film washing method includes the steps of: transferring a film which is long and is an intermediate product of the battery separator in a longitudinal direction of the film; and washing the film by causing the film, which is being transferred, to sequentially pass through a washing liquid in a first washing tank and a washing liquid in a second washing tank.

According to the method, it is possible to wash away the remove-target substance from the film more efficiently than washing in only one washing tank. From this, it is possible to shorten a transferring distance of the film which is being washed. This makes it possible to wash the film which is an intermediate product of a battery separator which is a porous film and whose mechanical strength is lower than a non-porous film while inhibiting a fold and a tear. As such, it is possible to carry out sufficient washing. Further, pores are formed at parts of the film from which parts the remove-target substance has been washed away. Therefore, it is possible to obtain the battery separator having an air permeability higher than that of a conventional battery separator.

In the film washing method of the present invention, the film can contain polyolefin as a main component.

According to the method, it is possible to obtain the polyolefin separator in which a fold and a tear are inhibited and which has an air permeability higher than that of a conventional polyolefin separator.

Another separator producing method of the present invention includes a forming step of forming a film which is long and is an intermediate product of a long and porous battery separator and the steps in the above described film washing method, the steps in the film washing method being carried out after the forming step.

According to the method, it is possible to produce the battery separator in which a fold and a tear are inhibited and which has an air permeability higher than that of a conventional battery separator.

### (Effect)

The separator washing method of the present embodiment is a method for washing a battery separator which is long and porous, and the separator washing method includes the steps of: transferring the battery separator in a longitudinal direction of the battery separator; and washing the battery separator by causing the battery separator, which is being transferred, to sequentially pass through a washing liquid in a first washing tank and a washing liquid in a second washing tank. With the configuration, it is possible to wash a porous separator whose mechanical strength is lower than a non-porous film while inhibiting a fold and a tear, and it is therefore possible to carry out sufficient washing. This makes it possible to bring about an effect of obtaining a battery separator having an air permeability higher than that of a conventional battery separator.

Moreover, the present embodiment includes a forming step of forming a long and porous battery separator and the steps in the separator washing method, the steps in the separator washing method being carried out after the forming step. This makes it possible to bring about an effect of producing the battery separator in which a fold and a tear are inhibited and which has an air permeability higher than that of a conventional battery separator.

The film washing method of the present embodiment is a method for obtaining a battery separator which is long and porous and the film washing method includes the steps of: transferring a film which is long and is an intermediate product of the battery separator in a longitudinal direction of the film; and washing the film by causing the film, which is being transferred, to sequentially pass through a washing liquid in a first washing tank and a washing liquid in a second washing tank. With the configuration, it is possible to bring about an effect of (i) washing the film which is an intermediate product of a battery separator, which is a porous film and whose mechanical strength is lower than that of a non-porous film, while inhibiting a fold and a tear, (ii) carrying out sufficient washing, and (iii) obtaining a battery separator having an air permeability higher than that of a conventional battery separator.

Moreover, the present embodiment includes a forming step of forming a film which is long and is an intermediate product of a long and porous battery separator and the steps in the above described film washing method, the steps in the film washing method being carried out after the forming step. This makes it possible to bring about an effect of producing the battery separator in which a fold and a tear are inhibited and which has an air permeability higher than that of a conventional battery separator.

### Embodiment 5

### Technical Field

The present embodiment relates to a method for producing a polarizing film which can be used as a constituent member for a polarizing plate.

### Background Art

In a conventional polarizing film, a dichromatic pigment such as iodine or a dichromatic dye is adsorption-oriented in a uniaxially stretched polyvinyl alcohol resin film. A polarizing film is generally used in a polarizing plate in which a protective film is bonded to one surface or both surfaces of the polarizing film with use of an adhesive, and is thus used in an image display device which is typically a liquid crystal display device such as a liquid crystal television, a monitor for a personal computer, and a mobile telephone.

In general, a polarizing film is produced by subjecting a long polyvinyl alcohol resin film, which is continuously transferred, to a swelling treatment, a dyeing treatment, a stretching treatment, a cross-linking treatment, and a washing treatment, and is then finally dried. Japanese Patent Application Publication, Tokukai, No. 2014-109740 A (Reference Document 1) discloses that it is possible to prevent a defect caused by a foreign crystalline substance or the like on a surface of a polarizing film, by blowing air to a polyvinyl alcohol resin film after a washing treatment so as to remove water.

### CITATION LIST

### Reference Document

### [Reference Document 1]

Japanese Patent Application Publication, Tokukai, No. 2014-109740 A

### SUMMARY OF EMBODIMENT

### Technical Problem

The polarizing film and the polarizing plate are demanded to be thinner, as compared with conventional ones. Reference Document 1 discloses that water can be removed without breaking a thin polyvinyl alcohol resin film by adjusting tension of the polyvinyl alcohol resin film while air is blown thereto, an airflow rate, and a distance from a tip of an air outlet opening to a surface of the film (see Table 1 of Reference Document 1).

As above described, the method of removing water by blowing air is complicated. An object of the present embodiment is to provide a method for producing a polarizing film which method can efficiently remove water with a simple method.

### Solution to Problem

The present embodiment provides a method below for producing a polarizing film.

[1] A method for producing a polarizing film from a polyvinyl alcohol resin film, the method including the steps of: processing the polyvinyl alcohol resin film by causing the polyvinyl alcohol resin film to make contact with a process liquid; and removing the process liquid adhering to a surface of the polyvinyl alcohol resin film by causing a liquid removing member to make contact with the polyvinyl alcohol resin film which has been processed, the processing step and the removing step being carried out in this order, a contact surface of the liquid removing member which contact surface makes contact with the polyvinyl alcohol resin film having a surface roughness Ra of 0.5 μm or less.

[2] The method described in [1] in which the contact surface of the liquid removing member has a water contact angle of 60° or smaller.

[3] The method described in [1] or [2] in which the liquid removing member has a plate-like shape; and in the removing step, the liquid removing member is caused to make contact with the polyvinyl alcohol resin film so that an angle formed by the polyvinyl alcohol resin film and the liquid removing member becomes an acute angle on an upstream side in a film transferring direction in which the polyvinyl alcohol resin film is transferred.

[4] The method described in [3] in which, in the removing step, the liquid removing member is caused to make contact with the polyvinyl alcohol resin film so that the angle formed by the polyvinyl alcohol resin film and the liquid removing member becomes 45° or smaller on the upstream side in the film transferring direction.

[5] The method described in [1] through [4] in which, in the removing step, an upstream space formed between the polyvinyl alcohol resin film and the liquid removing member is smaller than a downstream space formed between the polyvinyl alcohol resin film and the liquid removing member, the upstream space being formed on an upstream side, in the film transferring direction, from a contact position between the polyvinyl alcohol resin film and the liquid removing member, and the downstream space being formed on a downstream side, in the film transferring direction, from the contact position.

[6] The method described in [1] through [5] in which, in the removing step, the liquid removing member is configured to make contact with both surfaces of the polyvinyl alcohol resin film so that the process liquid adhering to the both surfaces of the polyvinyl alcohol resin film is removed.

[7] The method described in [1] through [6] in which the processing step is a swelling treatment step in which a swelling liquid is used as the process liquid, a dyeing treatment step in which a stain solution is used as the process liquid, a cross-linking treatment step in which a cross-linking solution is used as the process liquid, or a washing treatment step in which a washing liquid is used as the process liquid.

[8] The method described in [1] through [7] further includes the step of drying the polyvinyl alcohol resin film, the removing step being carried out after a last processing step included in the processing step and before the drying step.

### Advantageous Effects of Embodiment

According to the method of the present embodiment, it is possible, with the simple method, to efficiently remove water and to produce a polarizing film in which a defect is inhibited.

### BRIEF DESCRIPTION OF DRAWINGS

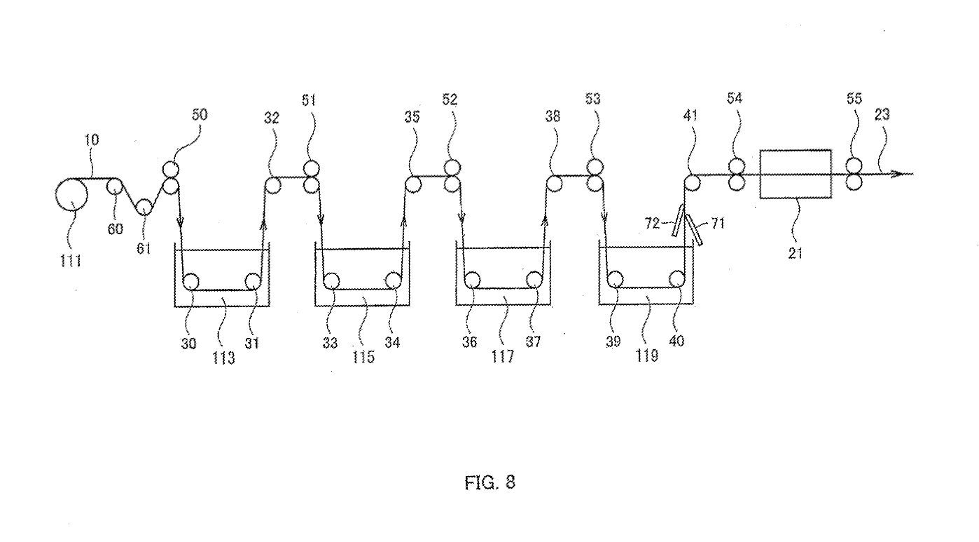

FIG. 8 is a cross-sectional view schematically illustrating an example of a method for producing a polarizing film of the present embodiment and a device for producing the polarizing film.

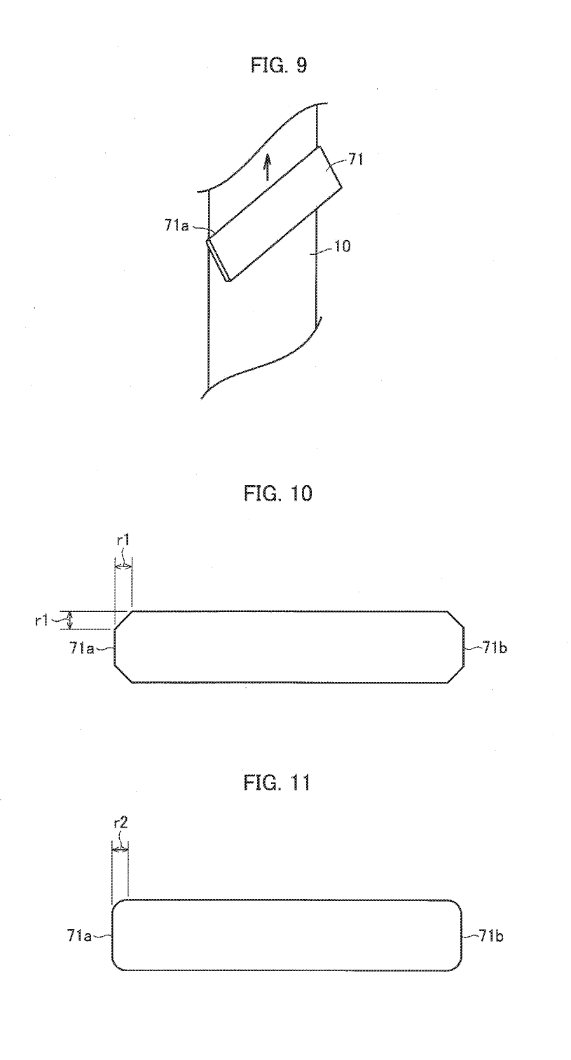

FIG. 9 is a perspective view schematically illustrating a liquid removing member illustrated in FIG. 8.

FIG. 10 is a cross-sectional view perpendicular to a length direction of a glass plate which has been chamfered.

FIG. 11 is a cross-sectional view perpendicular to a length direction of a glass plate which has been chamfered.

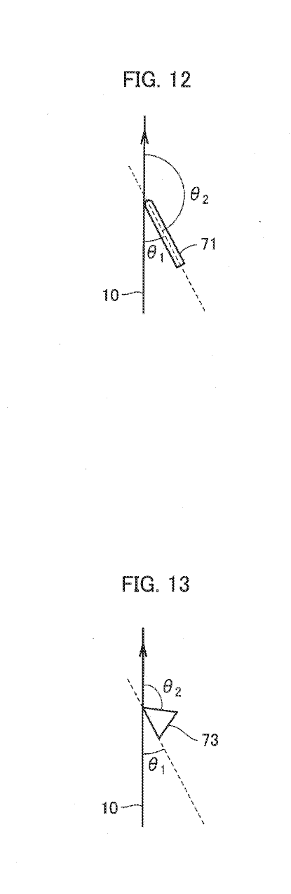

FIG. 12 is a cross-sectional view illustrating an angle formed between the liquid removing member illustrated in FIG. 8 and a film.

FIG. 13 is a cross-sectional view illustrating an angle formed between a liquid removing member having another shape and a film.

### DESCRIPTION OF EMBODIMENT

### Method for Producing Polarizing Film

In a polarizing film of the present embodiment, a dichromatic pigment (such as iodine or a dichromatic dye) is adsorption-oriented in a uniaxially stretched polyvinyl alcohol resin film. In general, polyvinyl alcohol resin constituting the polyvinyl alcohol resin film is obtained by saponifying polyvinyl acetate resin. A saponification ratio in this case is normally approximately 85 mol % or higher, preferably approximately 90 mol % or higher, more preferably approximately 99 mol % or higher. The polyvinyl acetate resin can be, for example, polyvinyl acetate which is a homopolymer of vinyl acetate, or a copolymer of vinyl acetate and another monomer which is copolymerizable with vinyl acetate. Examples of the copolymerizable another monomer encompass unsaturated carboxylic acids, olefins, vinyl ethers, unsaturated sulfonic acids, and the like. A degree of polymerization of polyvinyl alcohol resin is normally approximately 1000 to 10000, preferably approximately 1500 to 5000.

These polyvinyl alcohol resins can be denatured and, for example, it is possible to use polyvinyl formal, polyvinyl acetal, polyvinyl butyral, and the like each of which has been denatured by an aldehyde.

In the present embodiment, as an initiation material for producing a polarizing film, an unstretched polyvinyl alcohol resin film (original sheet film) is used which has a thickness of 65 μm or less (for example, 60 μm or less), preferably 50 μm or less, more preferably 35 μm or less, further preferably 30 μm or less. With this, it is possible to obtain a thin polarizing film which is increasingly demanded in the market. A width of the original sheet film is not particularly limited and can be, for example, approximately 400 mm to 6000 mm. The original sheet film is prepared as, for example, a roll (original sheet roll) of a long unstretched polyvinyl alcohol resin film.

The polarizing film can be continuously produced as a long polarizing film by carrying out (i) a prescribed processing step in which the long original sheet film is continuously transferred along a film transferring path of a device for producing a polarizing film while being wound off from the original sheet roll, soaked in a process liquid contained in a processing tank (hereinafter, the process liquid contained in the processing tank is also referred to as “processing bath”), and then pulled out from the process liquid and then (ii) a drying step. Note that the prescribed processing step is not limited to the method of soaking a film in the processing bath, provided that the film is processed by being caused to make contact with the process liquid. The prescribed processing step can be a method of processing a film by spraying, flowing-down, dropping, or the like the process liquid so that the process liquid adheres to a surface of the film.

Examples of the process liquid encompass a swelling liquid, a stain solution, a cross-linking solution, a washing liquid, and the like. Examples of the prescribed processing step encompass (i) a swelling treatment step of carrying out a swelling treatment by causing a swelling liquid to make contact with the original sheet film, (ii) a dyeing treatment step of carrying out a dyeing treatment by causing a stain solution to make contact with a film after the swelling treatment, (iii) a cross-linking treatment step of carrying out a cross-linking treatment by causing a cross-linking solution to make contact with a film after the dyeing treatment, and (iv) a washing treatment step of carrying out a washing treatment by causing a washing liquid to make contact with a film after the cross-linking treatment. Moreover, during these sequential processing steps (i.e., before and/or after any one or more of processing steps and/or during any one or more of the processing steps), a wet or dry uniaxial stretching treatment is carried out on the film. If needed, it is possible to add another processing step.

In the present embodiment, a process liquid removing step is carried out (i) on a film transferring path that is after one processing step and before a next processing step among the above processing steps or (ii) on a film transferring path that is after all the processing steps, in which the film is processed by being caused to make contact with the process liquid, and before the drying step. The process liquid removing step is a step of removing the process liquid, which has been used in a previous processing step and is adhering to the surface of the film, by causing a liquid removing member to make contact with the film which has been processed with the process liquid. In a case where the process liquid remains on the surface of the film in the drying step, a defect such as a foreign crystalline substance is likely to occur. Therefore, in view of inhibiting a defect occurring in the polarizing film, it is preferable to carry out the process liquid removing step on the film transferring path that is after all the processing steps, in which the film is processed by being caused to make contact with the process liquid, and before the film is introduced to the drying step. The number of carrying out the process liquid removing step is not limited to one, and the process liquid removing step can be carried out two times or more. The process liquid removing step can be carried out after each of all the processing steps in which the process liquid is used.

In the process liquid removing step of the present embodiment, a liquid removing member is used whose surface to contact with a polyvinyl alcohol resin film has a surface roughness Ra of 0.5 μm or less, preferably 0.3 μm or less. In a case where the surface roughness Ra exceeds 0.5 μm, it is sometimes impossible to sufficiently remove the process liquid which is adhering to the surface of the film. This may be because of the following reason: that is, in a case where the surface roughness Ra exceeds 0.5 μm, the process liquid adhering to the film goes into recesses of such an uneven surface of the liquid removing member, and this causes decrease in liquid removing property. In a case where the liquid removing member having the surface roughness of 0.5 μm or less is used, it is possible to inhibit damage on the surface of the film caused due to the contact. Here, the surface of the liquid removing member which surface makes contact with the polyvinyl alcohol resin film is a surface of the liquid removing member which surface is nearest to the surface of the polyvinyl alcohol resin film on a downstream side, in a film transferring direction, of the polyvinyl alcohol resin film from a position at which the polyvinyl alcohol resin film and the liquid removing member make contact with each other. The liquid removing member preferably has a length which is equal to or longer than a width direction length of the film, and is preferably arranged to make contact with the film across an entire width of the film. Details of the liquid removing member will be described later.

In a case where nip rollers are provided on the transferring path on which the process liquid removing step is carried out, the liquid removing member is preferably provided on an upstream side from the nip rollers. The process liquid adhering to the surface of the polyvinyl alcohol resin film may be spread or go into the polyvinyl alcohol resin film by passage through the nip rollers. In view of this, by carrying out the process liquid removing step before passing the polyvinyl alcohol resin film through the nip rollers, it is possible to effectively remove the process liquid, and it is thus possible to further inhibit a defect caused by the adhering process liquid.

The following description will discuss details of an example of a method for producing the polarizing film of the present embodiment, with reference to FIG. 8. FIG. 8 is a cross-sectional view schematically illustrating an example of a method for producing the polarizing film of the present embodiment and a polarizing film producing device for use in the method. The polarizing film producing device illustrated in FIG. 8 is configured to transfer an original sheet (unstretched) film 10 made of polyvinyl alcohol resin along a film transferring path while continuously winding off the original sheet film 10 from an original sheet roll 111 so that the original sheet film 10 sequentially passes through a swelling bath (i.e., a swelling liquid contained in a swelling tank) 113, a dyeing bath (i.e., a stain solution contained in a dyeing tank) 115, a cross-linking bath (i.e., a cross-linking solution contained in a cross-linking tank) 117, and a washing bath (i.e., a washing liquid contained in a washing tank) 119 (liquid tank) which are provided on the film transferring path, and finally through a drying oven 21. A polarizing film 23 (film) thus obtained can be, for example, transferred as it is to a next polarizing plate preparing step (i.e., a step of bonding a protective film to one surface or both surfaces of the polarizing film 23). The arrow in FIG. 8 indicates a direction of transferring the film.

In the example illustrated in FIG. 8, each of the swelling bath 113, the dyeing bath 115, the cross-linking bath 117, and the washing bath 119 is provided by one. Note, however, that, according to need, it is possible to provide two or more of any one or more of the processing baths. In the descriptions of FIG. 8, the term “processing tank” collectively indicates the swelling tank, the dyeing tank, the cross-linking tank, and the washing tank; the term “process liquid” collectively indicates the swelling liquid, the stain solution, the cross-linking solution, and the washing liquid; and the term “processing bath” collectively indicates the swelling bath, the dyeing bath, the cross-linking bath, and the washing bath.

The film transferring path in the polarizing film producing device can be constituted by providing, besides the processing baths, (i) guide rollers 30 through 41, 60, and 61 which can support the transferred film and can further change the film transferring direction and (ii) nip rollers 50 through 55 which can apply driving force to the film by sandwiching the transferred film with pressure while rotating and can further change the film transferring direction, at appropriate positions. The guide rollers and the nip rollers can be provided in front of, in back of, or inside of each of the processing baths, and this makes it possible to introduce and soak the film in the processing bath and to pull out the film from the processing bath (see FIG. 8). For example, by providing one or more guide rollers in each of the processing baths and transferring the film along the guide rollers, it is possible to soak the film in each of the processing baths.

In the polarizing film producing device illustrated in FIG. 8, nip rollers (i.e., nip rollers 50 through 54) are provided in front of and in back of each of the processing baths, and this makes it possible to carry out roller-to-roller stretching in which vertical one axis stretching is conducted by causing a circumferential speed to be different between two sets of the nip rollers which sets are provided in front of and in back of any one or more of the processing baths.

In the polarizing film producing device illustrated in FIG. 8, liquid removing members 71 and 72 (first member) are provided to as to make contact with the film on the transferring path downstream from the washing bath 119, and the process liquid removing step is carried out after the washing treatment step and before the drying step. The following description will discuss each of the steps.

### (Swelling Treatment Step)

The swelling treatment step is carried out in order to remove a foreign substance on the surface of the original sheet film 10, to remove a plasticizer in the original sheet film 10, to give easy-stainability, to plasticize the original sheet film 10, and the like. Treatment conditions are determined within a range in which the above object can be attained and in which defects such as excessive dissolution, devitrification, and the like of the original sheet film 10 do not occur.

According to FIG. 8, the swelling treatment step can be carried out by (i) transferring the original sheet film 10 along the film transferring path while continuously winding off the original sheet film 10 from the original sheet roll 111, (ii) soaking the original sheet film 10 in the swelling bath 113 for a prescribed time period, and then pulling out the original sheet film 10 from the swelling bath 113. In the example illustrated in FIG. 8, the original sheet film 10 is transferred along the film transferring path constituted by the guide rollers 60 and 61 and the nip rollers 50 after being wound off and before being soaked in the swelling bath 113. In the swelling treatment, the original sheet film 10 is transferred along the film transferring path constituted by the guide rollers 30 through 32.

The swelling liquid which is the swelling bath 113 can be, instead of pure water, an aqueous solution to which boric acid (Japanese Patent Application Publication, Tokukaihei, No. 10-153709 A (1998)), chloride (Japanese Patent Application Publication, Tokukaihei, No. 06-281816 A (1994)), inorganic acid, inorganic salt, water-soluble organic solvent, alcohols, or the like is added by approximately 0.01 wt % to 10 wt %.

A temperature of the swelling bath 113 is, for example, approximately 10° C. to 50° C., preferably approximately 10° C. to 40° C., more preferably approximately 15° C. to 30° C. A time period for soaking the original sheet film 10 is preferably approximately 10 seconds to 300 seconds, more preferably approximately 20 seconds to 200 seconds. In a case where the original sheet film 10 is a polyvinyl alcohol resin film which has been stretched in a gas in advance, a temperature of the swelling bath 113 is, for example, approximately 20° C. to 70° C., preferably approximately 30° C. to 60° C. A time period for soaking the original sheet film 10 is preferably approximately 30 seconds to 300 seconds, more preferably approximately 60 seconds to 240 seconds.

In the swelling treatment, a problem is more likely to occur in which the original sheet film 10 swells in the width direction and is therefore wrinkled. As one means for transferring the film while preventing the wrinkle, it is possible to use, as the guide rollers 30, 31 and/or 32, (i) a roller such as an expander roller, a spiral roller, or a crown roller which has a widening function or (ii) another widening device such as a cloth guider, a bend bar, or a tenter clip. Another means for preventing a wrinkle is to carry out a stretching treatment. For example, it is possible to carry out a uniaxial stretching treatment in the swelling bath 113 by utilizing a difference in circumferential speed between (i) the nip rollers 50 and (ii) the nip rollers 51.

In the swelling treatment, the film swells and expands also in the film transferring direction. Therefore, in a case where the film is not proactively stretched, for example, it is preferable to provide means for controlling a speed of the nip rollers 50 and 51 which are provide in front and in back of the swelling bath 113, in order to prevent sag of the film in the film transferring direction. Alternatively, in order to stabilize film transfer in the swelling bath 113, it is useful to control a water flow in the swelling bath 113 by an underwater shower, or to use an edge position control (EPC) device (which detects an edge of a film so as to prevent meandering of the film) or the like in combination with the underwater shower.

In the example illustrated in FIG. 8, the film pulled out from the swelling bath 113 sequentially passes through the guide roller 32 and the nip rollers 51 and is then introduced to the dyeing bath 115.

### (Dyeing Treatment Step)

The dyeing treatment step is carried out in order to cause a dichromatic pigment to be adsorbed onto the polyvinyl alcohol resin film which has been subjected to the swelling treatment and to orient the dichromatic pigment on the polyvinyl alcohol resin film. Treatment conditions are determined within a range in which the above object can be attained and in which defects such as excessive dissolution, devitrification, and the like of the film do not occur. The dyeing treatment step can be carried out by (i) transferring the film, which has been subjected to the swelling treatment, along a film transferring path constituted by the guide rollers 33 through 35 and the nip rollers 51, (ii) soaking the film in the dyeing bath 115 (i.e., the process liquid contained in the dyeing tank) for a prescribed time period, and then (iii) pulling out the film from the dyeing bath 115 (see FIG. 8). In order to enhance dye-affinity to the dichromatic pigment, the film which is to be subjected to the dyeing treatment step is preferably a film which has been subjected to a uniaxial stretching treatment to at least some extent. It is preferable that the uniaxial stretching treatment (i) is carried out only during the dyeing treatment instead of being carried out before the dyeing treatment or (ii) is carried out before and during the dyeing treatment.

In a case where iodine is used as the dichromatic pigment, the stain solution which is the dyeing bath 115 can be, for example, an aqueous solution in which a concentration is as follows: iodine/potassium iodide/water=approximately 0.003 to 0.3/approximately 0.1 to 10/100 in terms of weight ratio. Instead of potassium iodide, it is possible to use other iodide such as zinc iodide, or it is possible to use potassium iodide in combination with other iodide. Moreover, a compound other than iodide, e.g., boric acid, zinc chloride, cobalt chloride, and/or the like can coexist. In a case where boric acid is added, the dyeing treatment step is distinguished from the cross-linking treatment (described below) in that the stain solution contains iodine, and an aqueous solution which contains iodine by approximately 0.003 parts by weight or more relative to 100 parts by weight of water can be regarded as the dyeing bath 115. A temperature of the dyeing bath 115 in which the film is soaked is normally approximately 10° C. to 45° C., preferably 10° C. to 40° C., more preferably 20° C. to 35° C. A time period for soaking the film is normally approximately 30 seconds to 600 seconds, preferably 60 seconds to 300 seconds.

In a case where a water-soluble dichromatic dye is used as the dichromatic pigment, the stain solution which is the dyeing bath 115 can be, for example, an aqueous solution in which a concentration is as follows: dichromatic dye/water=approximately 0.001 to 0.1/100 in terms of weight ratio. In the dyeing bath 115, a dyeing assistant and/or the like can coexist, and the dyeing bath 115 can contain, for example, inorganic salt such as sodium sulfate, a surfactant, and/or the like. The dichromatic dye can be used solely or two or more dichromatic dyes can be used in combination. A temperature of the dyeing bath 115 in which the film is soaked is, for example, approximately 20° C. to 80° C., preferably 30° C. to 70° C. A time period for soaking the film is normally approximately 30 seconds to 600 seconds, preferably 60 seconds to 300 seconds.

As above described, in the dyeing treatment step, it is possible to uniaxially stretch the film in the dyeing bath 115. The uniaxial stretching of the film can be carried out with a method in which, for example, a circumferential speed is caused to be different between (i) the nip rollers 51 provided in front of the dyeing bath 115 and (ii) the nip rollers 52 provided in back of the dyeing bath 115.

In the dyeing treatment also, as with the swelling treatment, in order to transfer the polyvinyl alcohol resin film while preventing a wrinkle, it is possible to use, as the guide rollers 33, 34 and/or 35, (i) a roller such as an expander roller, a spiral roller, or a crown roller which has a widening function or (ii) another widening device such as a cloth guider, a bend bar, or a tenter clip. Another means for preventing a wrinkle is to carry out a stretching treatment, as with the swelling treatment.

In the example illustrated in FIG. 8, the film pulled out from the dyeing bath 115 sequentially passes through the guide roller 35 and the nip rollers 52 and is then introduced to the cross-linking bath 117.

### (Cross-Linking Treatment Step)

The cross-linking treatment step is carried out in order to add water resistance to and adjust hue of (e.g., prevent the film from becoming bluish) the film by cross-linking. The cross-linking treatment can be carried out by (i) transferring the film along a film transferring path constituted by the guide rollers 36 through 38 and the nip rollers 52, (ii) soaking the film, which has been subjected to the dyeing treatment, in the cross-linking bath 117 (i.e., the cross-linking solution contained in the cross-linking tank) for a prescribed time period, and then (iii) pulling out the film from the cross-linking bath 117 (see FIG. 8).

The cross-linking solution which is the cross-linking bath 117 can be an aqueous solution which contains boric acid by, for example, approximately 1 part by weight to 10 parts by weight relative to 100 parts by weight of water. In a case where the dichromatic pigment used in the dyeing treatment is iodine, the cross-linking solution preferably contains iodide in addition to boric acid, and an amount of iodide can be, for example, 1 part by weight to 30 parts by weight relative to 100 parts by weight of water. Iodide can be potassium iodide, zinc iodide, or the like. Moreover, a compound other than iodide can coexist. Examples of such a compound encompass zinc chloride, cobalt chloride, zirconium chloride, sodium thiosulfate, potassium sulfite, sodium sulfate, and the like.

In the cross-linking treatment, concentrations of boric acid and iodide and a temperature of the cross-linking bath 117 can be changed as appropriate depending on purposes. For example, in a case where a purpose of the cross-linking treatment is to addition of water resistance by cross-linking and the polyvinyl alcohol resin film is subjected to the swelling treatment, the dyeing treatment, and the cross-linking treatment in this order, a liquid which is the cross-linking bath contains a cross-linking agent can be an aqueous solution in which a concentration is as follows: boric acid/iodide/water=3 to 10/1 to 20/100 in terms of weight ratio. If needed, another cross-linking agent such as glyoxal or glutaraldehyde can be used instead of boric acid, or boric acid can be used in combination with such another cross-linking agent. A temperature of the cross-linking bath in which the film is soaked is normally approximately 50° C. to 70° C., preferably 53° C. to 65° C. A time period for soaking the film is normally approximately 10 seconds to 600 seconds, preferably 20 seconds to 300 seconds, more preferably 20 seconds to 200 seconds. In a case where a polyvinyl alcohol resin film which has been stretched in advance before the swelling treatment is subjected to the dyeing treatment and the cross-linking treatment in this order, a temperature of the cross-linking bath 117 is normally approximately 50° C. to 85° C., preferably 55° C. to 80° C.

In a case where the purpose of the cross-linking treatment is to adjust hue and, for example, iodine is used as the dichromatic pigment, it is possible to use a liquid containing a cross-linking agent in which liquid a concentration is as follows: boric acid/iodide/water=1 to 5/3 to 30/100 in terms of weight ratio. A temperature of the cross-linking bath in which the film is soaked is normally approximately 10° C. to 45° C. A time period for soaking the film is normally 1 second to 300 seconds, preferably 2 seconds to 100 seconds.

The cross-linking treatment can be carried out two or more times, and is normally carried out 2 to 5 times. In this case, compositions and temperatures of respective used cross-linking baths can be identical with each other or different from each other, provided that the compositions and temperatures fall within the above described range. The cross-linking treatment for adding water resistance by cross-linking and the cross-linking treatment for adjusting hue can be each carried out with a plurality of steps.

It is also possible to carry out a uniaxial stretching treatment in the cross-linking bath 117 by utilizing a difference in circumferential speed between (i) the nip rollers 52 and (ii) the nip rollers 53.

In the cross-linking treatment also, as with the swelling treatment, in order to transfer the polyvinyl alcohol resin film while preventing a wrinkle, it is possible to use, as the guide rollers 36, 37 and/or 38, (i) a roller such as an expander roller, a spiral roller, or a crown roller which has a widening function or (ii) another widening device such as a cloth guider, a bend bar, or a tenter clip. Another means for preventing a wrinkle is to carry out a stretching treatment, as with the swelling treatment.

In the example illustrated in FIG. 8, the film pulled out from the cross-linking bath 117 sequentially passes through the guide roller 38 and the nip rollers 53 and is then introduced to the washing bath 119.

### (Washing Treatment Step)

The example illustrated in FIG. 8 includes a washing treatment step which is carried out after the cross-linking treatment step. The washing treatment is carried out in order to remove a superfluous chemical agent such as boric acid and iodine which are adhering to the polyvinyl alcohol resin film. For example, the washing treatment step is carried out by soaking, in the washing bath 119, the polyvinyl alcohol resin film which has been subjected to the cross-linking treatment. Note that, instead of soaking the film in the washing bath 119, the washing treatment step can be carried out (i) by spraying shower of a washing liquid onto the film or (ii) by spraying the washing liquid in combination with soaking in the washing bath 119.

FIG. 8 illustrates the example in which the washing treatment is carried out by soaking the polyvinyl alcohol resin film in the washing bath 119. A temperature of the washing bath 119 in the washing treatment is normally approximately 2° C. to 40° C., and a time period for soaking the film is normally approximately 2 seconds to 120 seconds.

Note that, in the washing treatment also, in order to transfer the polyvinyl alcohol resin film while preventing a wrinkle, it is possible to use, as the guide rollers 39, 40 and/or 41, (i) a roller such as an expander roller, a spiral roller, or a crown roller which has a widening function or (ii) another widening device such as a cloth guider, a bend bar, or a tenter clip. Moreover, in the film washing treatment, it is possible to carry out a stretching treatment in order to prevent a wrinkle.

### (Stretching Treatment Step)

As early described, during the sequential processing steps (i.e., before and/or after any one or more of processing steps and/or during any one or more of the processing steps), a wet or dry uniaxial stretching treatment is carried out on the original sheet film 10. The uniaxial stretching treatment can specifically be, for example, a roller-to-roller stretching in which vertical one axis stretching is carried out by causing two sets of nip rollers (for example, a set of nip rollers provided in front of the processing bath and a set of nip rollers provided in back of the processing bath) constituting a film transferring path to be different in circumferential speed; heated roller stretching as disclosed in Japanese Patent No. 2731813; tenter stretching; or the like, and is preferably the roller-to-roller stretching. The uniaxial stretching treatment step can be carried out by a plural number of times until the polarizing film 23 is obtained from the original sheet film 10. As early described, the stretching treatment is effective for inhibiting a wrinkle of the film.

An eventual cumulative stretch magnification of the polarizing film 23 relative to the original sheet film 10 is approximately 4.5 times to 7 times, preferably 5 times to 6.5 times. The stretching treatment step can be carried out in any of the processing steps. In a case where the stretching treatment is carried out in two or more processing steps also, the stretching treatment can be carried out in any of the processing steps.

### (Process Liquid Removing Step)

In the example illustrated in FIG. 8, the process liquid removing step of removing the washing liquid is carried out after the washing treatment step. The process liquid removing step in the example illustrated in FIG. 8 is carried out with use of liquid removing members 71 and 72 which are respectively provided on both surfaces of the film. In the process liquid removing step, the liquid removing members 71 and 72 are provided so as to make contact with the respective surfaces of the transferred film, and thus the washing liquid adhering to the surfaces of the film is removed from the surfaces of the film when the film passes through the liquid removing members 71 and 72. As illustrated in FIG. 8, the liquid removing members 71 and 72 are preferably arranged in respective positions which are different in the film transferring direction so that the liquid removing members 71 and 72 do not make contact with the film at the same position. With the arrangement, it is possible to lower a load exerted on the film by contacts of the liquid removing members 71 and 72.

The process liquid removing step is preferably carried out so that the washing liquid is removed from the surfaces of the film by the liquid removing members 71 and 72 and the washing liquid thus removed is collected in the washing bath 119. For example, in the example illustrated in FIG. 8, the liquid removing members 71 and 72 are provided above the washing bath 119 via an opening, and it is therefore possible to collect the removed washing liquid in the washing bath 119. Note that, in a case where the liquid removing member is provided downstream from a processing step other than the washing treatment step, it is also preferable to similarly configure the liquid removing member so that the process liquid is collected in a processing tank provided upstream from the liquid removing member. By collecting the process liquid in the processing tank, it is possible to prevent reduction of the process liquid in the processing tank.

FIG. 9 is a perspective view schematically illustrating the liquid removing member 71 illustrated in FIG. 8. The liquid removing member 71 has a plate-like shape whose length is equal to or longer than a length of the original sheet film 10 in a width direction of the original sheet film 10. The liquid removing member 71 is preferably arranged so as to make contact with the film while a length direction of the liquid removing member 71 substantially conforms to the width direction of the film. With the arrangement, the film is to entirely make contact with the liquid removing member 71 in the width direction of the film. The liquid removing member 71 is arranged so that a lateral surface 71a of the liquid removing member 71 in the length direction makes contact with the film. A surface roughness Ra of the lateral surface 71a is 0.5 μm or less, more preferably 0.3 μm or less. In a case where the surface roughness Ra is greater than 0.5 μm, it is sometimes impossible to sufficiently remove the process liquid which is adhering to the surface of the film. The surface roughness Ra of the lateral surface 71a of the liquid removing member 71 can be adjusted by, for example, changing a degree of polishing the lateral surface 71a. The lateral surface 71a is preferably subjected to polishing after being chamfered by angular chamfering, round chamfering, or the like. The polishing method can be a publicly known method such as grindstone polishing, mirror grinding, lapping, buffing, flame polishing, or the like. A surface roughness Ra achieved by a normal polishing treatment is 0.001 μm.

The liquid removing member 71 is arranged so that the lateral surface 71a makes contact with the film at a water contact angle which is preferably 60° or smaller, more preferably 45° or smaller. In a case where the water contact angle exceeds 60°, an amount of the process liquid to be held in a space between the liquid removing member and the film is reduced, and therefore water removing property may decrease. The water contact angle of the liquid removing member 71 can be adjusted by, for example, changing a material used to prepare the liquid removing member 71. A material with which the water contact angle of the liquid removing member can be adjusted to be 60° or smaller can be glass, ceramics, metal (such as stainless steel, aluminum, iron), resin, or the like. Note that, in order to set the water contact angle to be an intended angle, it is possible to carry out a hydrophilization treatment on the material. Among the materials, glass or ceramics which has been subjected to the hydrophilization treatment is preferably used because of its good abradability and corrosion resistance, and glass is preferably used because of its good persistence of hydrophilicity. Glass may be an ordinarily used one, and can be silica glass, soda-lime glass, potash glass, borosilicate glass, or the like. Alternatively, in order to improve strength, it is possible to laminate a plurality of glass plates. In general, a water contact angle of glass is 3° to 45°.

Note that the above described water contact angle of the liquid removing member is limited to the surface of the liquid removing member which surface makes contact with the film, and therefore it is possible to provide a thin film, which is made of a material having an intended water contact angle, to a surface which is of the liquid removing member made of a material having corrosion resistance and is to contact with the film. A thickness of the liquid removing member 71 is not particularly limited and can be, for example, 1 mm to 20 mm.

The liquid removing member 71 can be prepared from, for example, a glass plate by chamfering the lateral surface 71a in the length direction. Moreover, a lateral surface 71b which is opposite to the lateral surface 71a can also be chamfered. Each of FIGS. 10 and 11 is a cross-sectional view of a chamfered glass plate seen in the length direction. A method of chamfering is not limited and, for example, it is possible to carry out angular chamfering so that each of vertices of the cross section perpendicular to the length direction has an obtuse angle (see FIG. 10). A chamfer dimension r1 in the angular chamfering is, for example, 0.5 mm to 2 mm. Alternatively, for example, it is possible to carry out round chamfering so that each of vertices of the cross section perpendicular to the length direction has a round shape (see FIG. 11). A radius of curvature r2 in the round chamfering is, for example, 0.5 mm to 2 mm.

In the polarizing film producing device illustrated in FIG. 8, an angle formed between the polyvinyl alcohol resin film 10 and the liquid removing member 71 is preferably an acute angle on an upstream side in the direction of transferring the polyvinyl alcohol resin film 10, more preferably 45° or smaller, further preferably 30° or smaller. FIG. 12 indicates an angle formed between the polyvinyl alcohol resin film 10 and the liquid removing member 71. In FIG. 12, an angle θ1 is an angle formed on the upstream side in the direction of transferring the polyvinyl alcohol resin film 10, and an angle θ2 is an angle formed on a downstream side in the film transferring direction. That is, the angle θ1 is preferably an acute angle, more preferably 45° or smaller, further preferably 30° or smaller.

As such, in a case where the angle θ1 is an acute angle, that is, in a case where angle θ1<angle θ2, it is possible to further improve the liquid removing property. This seems to be because of the following reason: that is, an upstream space is formed between the original sheet film 10 and the liquid removing member 71 on an upstream side, in the film transferring direction, from a contact position between the original sheet film 10 and the liquid removing member 71; a downstream space is formed between the original sheet film 10 and the liquid removing member 71 on a downstream side, in the film transferring direction, from the contact position; and the upstream space is smaller than the downstream space, and therefore the process liquid is more likely to stay in the upstream space by capillary force, rather than to move to the downstream space when the liquid removing member 71 relatively moves on the surface of the original sheet film 10. In FIGS. 9 through 12, the liquid removing member 71 has been described. These descriptions of the liquid removing member 71 apply to the liquid removing member 72 which is provided on the other surface of the original sheet film 10. Note that the process liquid removing step is not limited to the method of providing the liquid removing members 71 and 72 on opposite sides as illustrated in FIG. 8. Alternatively, a liquid removing member can be provided on only one side surface of a film or a plurality of liquid removing members can be provided on one side surface of a film. For example, in a device in which a film transferring path inclines in the vertically downward direction and the process liquid is more likely to adhere only to an upper surface of the film, a liquid removing member can be provided only on the upper surface of the film. In view of improving the liquid removing property, it is preferable to employ the configuration in which the liquid removing members are provided on both surfaces of the film.

In FIGS. 8 through 12, the liquid removing member 71 having the plate-like shape is described. The liquid removing member used in the process liquid removing step is not limited to the plate-like shape, provided that the liquid removing member can remove, by contact, the process liquid adhering to the surface of the film. For example, it is possible to employ (i) a liquid removing member having a prismatic shape such as a triangular prism shape or a quadrangular prism shape or (ii) a liquid removing member having a columnar shape. Even in a case where a liquid removing member having a shape other than the plate-like shape, the descriptions (regarding the intended surface roughness, the intended water contact angle, and the material of the surface to contact with the film) of the liquid removing member 71 having the plate-like shape apply. FIG. 13 is a cross-sectional view illustrating a relation between the original sheet film 10 and a liquid removing member 73 (first member) which has a triangular prism shape. In view of improving the liquid removing property, it is preferable to bring the liquid removing member 73 into contact with the original sheet film 10 so that a space formed between the liquid removing member 73 and the original sheet film 10 on an upstream side from the contact position in the film transferring direction is smaller than a space formed between the liquid removing member 73 and the original sheet film 10 on a downstream side in the film transferring direction. That is, angles between a surface of the liquid removing member 73 and the original sheet film 10 are preferably formed such that an upstream side angle θ1 is smaller than a downstream side angle θ2.

It is possible to provide a member similar to the above described process liquid removing member on a downstream upper side of the swelling bath 113, a downstream upper side of the dyeing bath 115, or a downstream upper side of the cross-linking bath 117. Further, as the process liquid removing step, it is possible to carry out (i) a step of removing the swelling liquid adhering to the surface of the film after the swelling treatment step, (ii) a step of removing the stain solution adhering to the surface of the film after the dyeing treatment step, and (iii) a step of removing the cross-linking solution adhering to the surface of the film after the cross-linking treatment step.

### (Drying Treatment Step)

It is preferable to carry out a treatment for drying the polyvinyl alcohol resin film after the washing treatment step. The drying of the film is not particularly limited and can be carried out with use of a drying oven 21 as in the example illustrated in FIG. 8. A drying temperature is, for example, approximately 30° C. to 100° C., and a drying time is, for example, approximately 30 seconds to 600 seconds. A thickness of a polarizing film 23 thus obtained is, for example, approximately 5 μm to 30 μm.

### (Other Processing Step on Polyvinyl Alcohol Resin Film)

It is possible to further carry out a processing step in addition to the above described processing steps. Examples of such an additional process encompass a soaking treatment (color complementary treatment) of soaking the film in an iodide aqueous solution containing no boric acid and a soaking treatment (zinc treatment) of soaking the film in an aqueous solution which does not contain boric acid and contains zinc chloride or the like. Note that each of these soaking treatments is carried out after the cross-linking treatment step.

### <Polarizing Plate>

A polarizing plate can be obtained by bonding a protective film, via an adhesive, to at least one surface of the polarizing film prepared as described above. Examples of the protective film encompass a film made of acetyl cellulose resin such as triacetyl cellulose or diacetyl cellulose; a film made of polyester resin such as polyethylene terephthalate, polyethylene naphthalate, or polybutylene terephthalate; a polycarbonate resin film; a cycloolefin resin film; an acrylic resin film; and a film made of chain olefin resin of polypropylene resin.

In order to improve adhesiveness between the polarizing film and the protective film, it is possible to carry out a surface treatment such as a corona treatment, a flame treatment, a plasma treatment, an ultraviolet irradiation, a primer applying treatment, or a saponification treatment on a bonding surface(s) of the polarizing film and/or the protective film. Examples of the adhesive used to bond the polarizing film and the protective film encompass an activation energy ray curing adhesive such as an ultraviolet curing adhesive; an aqueous solution of polyvinyl alcohol resin; an aqueous solution obtained by mixing a cross-linking agent with the aqueous solution of polyvinyl alcohol resin; and a water-based adhesive such as a urethane emulsion adhesive. The ultraviolet curing adhesive can be a mixture of an acrylic compound and a photo radical polymerization initiator, a mixture of an epoxy compound and a photo cation polymerization initiator, or the like. Alternatively, it is possible to use a cation polymerizable epoxy compound in combination with a radical polymerizable acrylic compound, and to use, as an initiator, a photo cation polymerization initiator in combination with a photo radical polymerization initiator.

### EXAMPLE

With use of plate-like liquid removing members similar to the liquid removing member illustrated in FIG. 9, liquid removing properties were evaluated. Note that the present embodiment is not limited to these examples. In the examples below, a surface roughness and a water contact angle of a surface of a liquid removing member which surface makes contact with a polyvinyl alcohol resin film were measured by the following method.

### <Measurement of Surface Roughness>

A surface roughness Ra of the surface of the liquid removing member which surface makes contact with the film was measured by a method conforming to JIS B 0601 with use of a surface roughness measuring device (HANDYSURF E-35A, manufactured by Tokyo Seimitsu Co., Ltd.) Measurement conditions (cutoff length, evaluation length) for measuring the surface roughness Ra were set as appropriate based on a surface roughness Ra obtained by JIS B0633. That is, in a case where the surface roughness Ra was more than 0.006 μm and 0.02 μm or less, the cutoff length was 0.08 mm and the evaluation length was 0.4 mm; in a case where the surface roughness Ra was more than 0.02 μm and 0.1 μm or less, the cutoff length was 0.25 mm and the evaluation length was 1.25 mm; in a case where the surface roughness Ra was more than 0.1 μm and 2 μm or less, the cutoff length was 0.8 mm and the evaluation length was 4 mm; and in a case where the surface roughness Ra was more than 2 μm and 10 μm or less, the cutoff length was 2.5 mm and the evaluation length was 12.5 mm.

### <Measurement of Water Contact Angle>

With use of an image processing contact angle meter (FACE CA-X, manufactured by Kyowa Interface Science Co., Ltd.), 1 microliter of pure water was dropped to the surface of the liquid removing member and a water contact angle was measured.

### <Evaluation Test 1 for Liquid Removing Property>

Plate-like liquid removing members for respective Examples 1 through 8 and Comparative Examples 1 through 3 were prepared, which were different in material and degree of polishing of surface to contact with the film, and evaluated as follows. Table 1 below indicates (i) materials of the respective liquid removing members, (ii) surface roughnesses of surfaces of the respective liquid removing members which surfaces make contact with the film, and (iii) water contact angles which were measured by the above described method.

Onto a surface of a polarizing film (having a width of 30 mm, a thickness of 22 μm) which was horizontally held with a tension of 35 N/m, 40 microliters of pure water was dropped. Next, the liquid removing member was brought into contact with the surface of the polarizing film, onto which surface the pure water had been dropped, at an angle (which was formed between the polarizing film and the liquid removing member on an upstream side in a relative movement direction of the polarizing film) indicated in Table 1 and was moved at a speed of 6 m/min. so as to remove the pure water. A state of the surface of the polarizing film, from which surface the pure water had been removed, was visually observed and thus the liquid removing property was evaluated. The liquid removing property was evaluated based on criterions “1” through “3” below. Table 1 indicates evaluation results. In the present evaluation test, the evaluation was carried out by moving the liquid removing member with respect to the polarizing film. Note, however, that, even by moving the polarizing film while fixing the liquid removing member (i.e., even with the relation in the device illustrated in FIG. 8), it is possible to assume that similar evaluation results would be obtained.

1: No water is observed on the polarizing film after the water removing process.

2: A thin film of water is observed on the polarizing film after the water removing process.

3: Water droplets are observed on the polarizing film after the water removing process.

TABLE 1

| | | | | Contact | Water |
|---|---|---|---|---|---|
| | Liquid removing member | | | angle | removing |
| | | Surface | | with | property |
| | Material | roughness | W.C.A. | film | evaluation |
| Example 1 | Glass | 0.01 μm | 44.7° | 30° | 1 |
| Example 2 | Glass | 0.05 μm | 44.7° | 30° | 1 |
| Example 3 | Glass | 0.09 μm | 44.7° | 30° | 1 |
| Example 4 | Iron (SS4OO) | 0.25 μm | 53.7° | 30° | 1 |
| Example 5 | Aluminum | 0.02 μm | 74.9° | 30° | 2 |
| | (A6061) | | | | |
| Example 6 | Aluminum | 0.25 μm | 74.9° | 30° | 2 |
| | (A6061) | | | | |
| Example 7 | Stainless-steel | 0.26 μm | 64.3° | 30° | 2 |
| | (SUS304) | | | | |
| Com. Ex. 1 | Iron (SS4OO) | 0.60 μm | 53.7° | 30° | 3 |
| Com. Ex. 2 | Aluminum | 1.78 μm | 74.9° | 30° | 3 |
| | (A6061) | | | | |
| Com. Ex. 3 | Stainless-steel | 2.27 μm | 64.3° | 30° | 3 |
| | (SUS304) | | | | |
| Example 8 | Glass | 0.01 μm | 44.7° | 60° | 2 |

Com. Ex.: Comparative Example
W.C.A.: Water contact angle

### <Evaluation Test 2 for Liquid Removing Property>

As Examples 9 and 10, liquid removing members similar to the liquid removing member prepared as Example 2 of the evaluation test 1 for liquid removing property were prepared, and evaluation below was carried out. In steps of continuously producing a polarizing film as illustrated in FIG. 8, the liquid removing member was brought into contact with the film, which had been pulled out from the washing bath and transferred, at an angle (which is formed between the polarizing film and the liquid removing member on an upstream side in a film transferring direction of the polarizing film) indicated in Table 2 so as to remove the liquid. Note that a film transferring speed was 10 m/min. A state of the surface of the polarizing film, from which surface the liquid had been removed, was visually observed and thus the liquid removing property was evaluated. The liquid removing property was evaluated based on criterions “1” through “3” below. Table 2 indicates evaluation results.

1: No water is observed on the polarizing film after the liquid removing process.

2: A thin film of water is observed on the polarizing film after the liquid removing process.

3: Water droplets are observed on the polarizing film after the liquid removing process.

TABLE 2

| | | | | Contact | Water |
|---|---|---|---|---|---|
| | Liquid removing member | | | angle | removing |
| | | Surface | | with | property |
| | Material | roughness | W.C.A. | film | evaluation |
| Example 9 | Glass | 0.05 μm | 44.7° | 30° | 1 |
| Example 10 | Glass | 0.05 μm | 44.7° | 15° | 1 |

W.C.A.: Water contact angle

As indicated in Examples, the present embodiment can be suitably used to produce a polarizing film from polyvinyl alcohol resin. Note that the liquid removing member of the present embodiment can be suitably used in functional resin film production including a step of processing a polymeric resin film by causing the polymeric resin film to make contact with a process liquid. For example, the liquid removing member of the present embodiment can be suitably used in a process liquid removing step in a method for producing a separator film for lithium secondary battery, as with the process liquid removing step on a polyvinyl alcohol resin film in the method for producing a polarizing film.

### REFERENCE SIGNS LIST

10: Original sheet film made of polyvinyl alcohol resin, 111: Original sheet roll, 113: Swelling bath, 115: Dyeing bath, 117: Cross-linking bath, 119: Washing bath, 21: Drying oven, 23: Polarizing film, 30, 31, 32, 33, 34, 35, 36, 37, 38, 39, 40, 41, 60, 61: Guide roller, 50, 51, 52, 53, 54, 55: Nip roller, 71, 72, 73: Liquid removing member.

### Main Points of Embodiment 5

The polarizing film producing method of the present invention is a method for producing a polarizing film (film) from a polyvinyl alcohol resin film, the method including the steps of: processing the polyvinyl alcohol resin film by causing the polyvinyl alcohol resin film to make contact with a process liquid (liquid); and removing the process liquid adhering to a surface of the polyvinyl alcohol resin film by causing a liquid removing member (first member) to make contact with the polyvinyl alcohol resin film which has been processed, the processing step and the removing step being carried out in this order, a contact surface of the liquid removing member which contact surface makes contact with the polyvinyl alcohol resin film having a surface roughness Ra of 0.5 μm or less.

In the method, it is preferable that the contact surface of the liquid removing member has a water contact angle of 60° or smaller.

In the method, it is preferable that the liquid removing member has a plate-like shape; and in the removing step, the liquid removing member is caused to make contact with the polyvinyl alcohol resin film so that an angle formed by the polyvinyl alcohol resin film and the liquid removing member becomes an acute angle on an upstream side in a film transferring direction in which the polyvinyl alcohol resin film is transferred.

In the method, it is preferable that, in the removing step, the liquid removing member is caused to make contact with the polyvinyl alcohol resin film so that the angle formed by the polyvinyl alcohol resin film and the liquid removing member becomes 45° or smaller on the upstream side in the film transferring direction.

In the method, it is preferable that, in the removing step, an upstream space formed between the polyvinyl alcohol resin film and the liquid removing member is smaller than a downstream space formed between the polyvinyl alcohol resin film and the liquid removing member, the upstream space being formed on an upstream side, in the film transferring direction, from a contact position between the polyvinyl alcohol resin film and the liquid removing member, and the downstream space being formed on a downstream side, in the film transferring direction, from the contact position.

In the method, it is preferable that, in the removing step, the liquid removing member is configured to make contact with both surfaces of the polyvinyl alcohol resin film so that the process liquid adhering to the both surfaces of the polyvinyl alcohol resin film is removed.

In the method, it is preferable that the processing step is a swelling treatment step in which a swelling liquid is used as the process liquid, a dyeing treatment step in which a stain solution is used as the process liquid, a cross-linking treatment step in which a cross-linking solution is used as the process liquid, or a washing treatment step in which a washing liquid is used as the process liquid.

The method preferably further includes the step of drying the polyvinyl alcohol resin film, the removing step being carried out after a last processing step included in the processing step and before the drying step.

### REFERENCE

The present invention can be expressed as the following reference invention.

### (Problem)

In Patent Literature 1, a heat-sealing multilayer sheet taken out from a washing liquid is transferred to heating means without being subjected to a water removing treatment. Meanwhile, in Patent Literature 2, an optical plastic film taken out from a washing liquid is transferred to a drying section via nip rollers and a water removing section which is an air knife.

Here, the nip rollers remove a liquid from a film by applying pressure to the film, and are therefore sometimes unsuitable for water removing from a film having a low mechanical strength. In particular, the nip rollers are not adequate to water removal from a porous separator having a low mechanical strength and an intermediate product film of the porous separator, as compared with a simple non-porous film.

Moreover, the air knife is means for removing a liquid from the film by blowing air to the film, and it is therefore necessary to provide an air supplying mechanism. Further, due to spatial restrictions and the like in the production process, it is sometimes impossible to use relatively complicated mechanisms such as a supporting mechanism and an air supplying mechanism.

An object of the present reference invention is to produce a film from which the liquid, which had been used in a washing treatment, has been removed in a film producing method including the washing treatment on the film which is long.

### (Means)

In order to attain the object, a film producing method of the present reference invention is a film producing method including a washing treatment on a film which is long, and the film producing method includes (i) a washing step of carrying out the washing treatment by passing the film through a liquid in a liquid tank and (ii) a first removing step of removing the liquid from the film by sliding a first member, which has a non-water-absorbing property, with respect to the film which has been taken out from the liquid.

According to the producing method, the first member slides with respect to the film and can thus remove, from the film, the liquid adhering to the film.

Here, if the first member has a water-absorbing property, the liquid is to be continuously absorbed by the first member, and this requires a mechanism for removing the liquid thus absorbed. For example, a sponge roller is used as the first member and a suction pump is used as a removing mechanism.

However, the sponge roller lacks durability. Moreover, the suction pump continuously consumes energy. As such, the first member having the water-absorbing property is not suitable for continuously removing water from the film.

On the other hand, according to the producing method of the present reference invention, it is unnecessary to provide such mechanisms. It is therefore possible to continuously remove the liquid from the film. From this, it is possible to produce the film from which the liquid, which had been used in the washing treatment, has been sufficiently removed.

Note that the phrase “slides with respect to the film” means that a part of the first member which part makes contact with the film and a part of the film which part makes contact with the first member move at different speeds. For example, a configuration in which the first member does not move and the film moves is encompassed in a configuration in which the first member slides with respect to the film.

In the film producing method of the present reference invention, it is preferable that the film includes a first layer and a second layer which is thinner than the first layer and, in the first removing step, the first member is provided on a first layer side of the film and no member which slides with respect to the film is provided on a second layer side of the film.

According to the producing method, it is possible to remove the liquid from the film without damaging the second layer. The second layer can be, for example, a functional layer such as a heat-resistant layer of the film.

In the film producing method of the present reference invention, it is preferable that the first member includes a sheet-like member which slides with respect to the film.

According to the producing method, a shape of the sheet-like member can be defined by, for example, providing another member inside the sheet-like member. With the configuration, it is possible to change force which is applied to the film when the liquid is removed from the film. This makes it possible to adjust the force in accordance with types of films.

In the film producing method of the present reference invention, it is preferable that the first member includes a guide roller whose axis is in parallel with the film and a bar-like member which is fixed on a film side along a surface of the guide roller, and the bar-like member is pressed against the film via the sheet-like member.

According to the producing method, the bar-like member is fixed on the film side along the surface of the guide roller whose axis is in parallel with the film. Therefore, the bar-like member is fixed in parallel with the film. On a side of the sheet-like member on which side the bar-like member is provided, a protrusion having a shape parallel with the film is formed. This protrusion slides with respect to the film, and thus the liquid is uniformly removed from the film.

In the film producing method of the present reference invention, it is preferable that a shape of a part of the first member which part slides with respect to the film is changed by replacing the bar-like member.

According to the producing method, it is possible to define the shape of the sheet-like member by replacing the bar-like member. This makes it possible to adjust, in accordance with types of films, the force which is applied to the film when the liquid is removed from the film.

In the film producing method of the present reference invention, it is preferable that the sheet-like member contains synthetic resin as a main component.

According to the producing method, for example, it is possible to slide the sheet-like member with respect to the film so as not to damage the film containing synthetic resin as a main component.

The film producing method of the present reference invention preferably further includes a second removing step of removing the liquid from a transferring roller for transferring the film which has been taken out from the liquid.

The liquid is adhering to the film which has been taken out from the liquid. Therefore, the liquid which has departed from the film attaches also to the transferring roller for transferring the film. The liquid adhering to the transferring roller is held on a surface of the transferring roller. Therefore, the liquid which has departed from the transferring roller may adhere to the film again.

According to the producing method, it is possible to remove the liquid from the transferring roller. From this, it is possible to prevent the liquid from adhering to the film again.

The film producing method of the present reference invention preferably further includes a driving step of pressing a driving roller against the film, which has been taken out from the liquid, before a drying treatment after the washing step or before another washing treatment, a holding angle of the driving roller with respect to the film being 180° or larger.

According to the producing method, the holding angle of the driving roller with respect to the film is 180° or larger, and therefore the film whose direction is changed sandwiches the driving roller. From this, it is possible to increase frictional force between the film and the driving roller, and to thus prevent the film from slipping on the driving roller. Further, the driving roller and the film closely make contact with each other, and the liquid is removed from between the driving roller and the film. As such, it is possible to remove the liquid from the film while applying transferring force to the film.

A film producing method of the present reference invention is a film producing method including a washing treatment on a film which is long, and the film producing method includes (i) a washing step of carrying out the washing treatment by passing the film through a liquid in a liquid tank and (ii) a second removing step of removing the liquid from a transferring roller for transferring the film which has been taken out from the liquid.

According to the producing method, it is possible to prevent the liquid from adhering to the film again. Therefore, it is possible to produce the film from which the liquid, which had been used in the washing treatment, has been sufficiently removed.

It is preferable in the film producing method of the present reference invention that, in the second removing step, the liquid is removed from the transferring roller by causing the liquid, which is adhering to the transferring roller, to move to the second member.

According to the producing method, for example, it is possible to cause the liquid, which is adhering to the transferring roller, to move to the second member while providing a gap between the transferring roller and the second member. It is therefore possible to remove the liquid from the film while preventing (i) damage on the surface of the transferring roller and (ii) abrasion of the second member.

In the film producing method of the present reference invention, it is preferable that at least one of the transferring roller and the second member for removing the liquid from the transferring roller contains synthetic resin as a main component.

According to the producing method, the main component of at least one of the transferring roller and the second member is synthetic resin. Therefore, a main component of a foreign substance, which is caused by abrasion of the member, is to be the synthetic resin. The foreign substance made of the synthetic resin less adversely influences the film, as compared with, for example, a metal foreign substance.

The film producing method of the present reference invention preferably further includes a driving step of pressing a driving roller against the film, which has been taken out from the liquid, before a drying treatment after the washing step or before another washing treatment, a holding angle of the driving roller with respect to the film being 180° or larger.

According to the producing method, it is possible to remove the liquid from the film while applying transferring force to the film.

A film producing method of the present reference invention is a film producing method including a washing treatment on a film which is long, and the film producing method includes: a washing step of carrying out the washing treatment by passing the film through a liquid in a liquid tank; and a driving step of pressing a driving roller against the film, which has been taken out from the liquid, before a drying treatment after the washing step or before another washing treatment, a holding angle of the driving roller with respect to the film being 180° or larger.

According to the producing method, it is possible to remove the liquid from the film while applying transferring force to the film. Therefore, it is possible to produce the film from which the liquid, which had been used in the washing treatment, has been sufficiently removed.

It is preferable that the film includes a first layer and a second layer which is thinner than the first layer, the driving roller is provided on a first layer side of the film in the driving step, and no driving roller which applies transferring force to the film is provided on a second layer side of the film.

According to the producing method, it is possible to remove the liquid from the film without damaging the second layer. The second layer can be, for example, a functional layer such as a heat-resistant layer of the film.

In the film producing method of the present reference invention, it is preferable that the liquid which has been removed from the film is returned to the liquid tank.

According to the producing method, it is possible to reuse the liquid, which has been removed from the film, in the liquid tank.

In particular, in a case where the film producing method includes at least two of the first removing step, the second removing step, and the driving step, it is possible to reuse, in the same liquid tank, the liquids which have been removed in different steps. From this, it is unnecessary to separately collect the liquids which have been removed in respective different steps. This makes it possible to simplify the washing device which is used in the washing treatment.

### (Technical Scope of Film Producing Method)

The film producing method includes the method for producing the polarizing film. Specifically, the “film” in the film producing method can be a polyvinyl alcohol resin film or a polarizing film formed from the polyvinyl alcohol resin film.

In the film producing method, the “washing step” can be a processing step of processing the polyvinyl alcohol resin film by causing the polyvinyl alcohol resin film to make contact with a process liquid.

In the film producing method, the “liquid” can be the process liquid which makes contact with the polyvinyl alcohol resin film in the processing step.

In the film producing method, the “first member” can be a liquid removing member which is brought into contact with the polyvinyl alcohol resin film after the processing step.

In the film producing method, the “first removing step” can be a process liquid removing step of removing the process liquid, which is adhering to a surface of the polyvinyl alcohol resin film, by bringing the liquid removing member into contact with the polyvinyl alcohol resin film after the processing step.

### (Effect)

The film producing method of the present reference invention brings about an effect of producing a film from which the liquid, which had been used in a washing treatment, has been sufficiently removed in a film producing method including the washing treatment on the film which is long.

### [Supplemental Notes]

The present invention is not limited to the embodiments, but can be altered by a skilled person in the art within the scope of the claims. An embodiment derived from a proper combination of technical means disclosed in respective different embodiments is also encompassed in the technical scope of the present invention.

### INDUSTRIAL APPLICABILITY

The present invention is also applicable to washing a film other than a separator.

### REFERENCE SIGNS LIST

4: Heat-resistant layer (second layer)
5: Porous film (first layer)
6: Washing device
15 through 19: Washing tank (liquid tank)
23: Polarizing film (film)
71 through 73: Liquid removing member (first member)
119: Washing bath (liquid tank)
BL: Scrape-off bar (second member)
G: Guide roller
R: Driving roller
S: Heat-resistant separator (battery separator, laminated separator, film)
W: Washing water (washing liquid, liquid, process liquid)
a through m: Roller (transferring roller)
p and q: Auxiliary roller
s: Teflon bar (bar-like member)
t: Teflon tube (sheet-like member, first member)
θ: Holding angle

1. A separator washing method for washing a battery separator which is long and porous, said separator washing method comprising the steps of:
transferring the battery separator in a longitudinal direction of the battery separator; and
washing the battery separator by causing the battery separator, which is being transferred, to sequentially pass through a washing liquid in a first washing tank and a washing liquid in a second washing tank.

2. The separator washing method as set forth in claim 1, further comprising the step of:
renewing washing liquids in the first washing tank and the second washing tank by supplying a washing liquid to the second washing tank and supplying the washing liquid of the second washing tank to the first washing tank.

3. The separator washing method as set forth in claim 1, wherein:
a concentration of a remove-target substance dispersed from the battery separator to the washing liquid in the second washing tank is lower than a concentration of a remove-target substance dispersed from the battery separator to the washing liquid in the first washing tank.

4. The separator washing method as set forth in claim 1, further comprising the step of:
removing the washing liquid from the battery separator between the first washing tank and the second washing tank.

5. The separator washing method as set forth in claim 1, further comprising the step of:
removing the washing liquid from a transferring roller for transferring the battery separator between the first washing tank and the second washing tank.

6. The separator washing method as set forth in claim 1, further comprising the step of:
circulating the washing liquid in order to facilitate interchanging of washing liquids between one surface side and another surface side of the battery separator in at least one of the first washing tank and the second washing tank.

7. The separator washing method as set forth in claim 1, wherein:
in the step of transferring the battery separator in the longitudinal direction, driving force for transferring the battery separator is applied to the battery separator between a position at which the battery separator is brought into the first washing tank and a position at which the battery separator is taken out from the second washing tank.

8. The separator washing method as set forth in claim 7, wherein:
the driving force is applied to the battery separator between a position at which the battery separator is taken out from the washing liquid in the first washing tank and a position at which the battery separator is brought into the washing liquid in the second washing tank.

9. A separator producing method for producing a separator, said separator producing method comprising:
a forming step of forming a battery separator which is long and porous; and
steps in a separator washing method recited in claim 1, the steps in the separator washing method being carried out after the forming step.

10. The separator producing method as set forth in claim 9, wherein:
the battery separator is a laminated separator including a base material and a functional layer laminated on the base material; and
the forming step includes (i) an applying step of applying a liquid substance containing a substance for constituting the functional layer to the base material so as to laminate the functional layer and (ii) a solidifying step of solidifying the substance after the applying step.

11. A film washing method for obtaining a battery separator which is long and porous, said film washing method comprising the steps of:
transferring a film which is long and is an intermediate product of the battery separator in a longitudinal direction of the film; and
washing the film by causing the film, which is being transferred, to sequentially pass through a washing liquid in a first washing tank and a washing liquid in a second washing tank.

12. The film washing method as set forth in claim 11, wherein the film contains polyolefin as a main component.

13. A separator producing method comprising:
a forming step of forming a film which is long and is an intermediate product of a long and porous battery separator; and
steps in a film washing method recited in claim 11, the steps in the film washing method being carried out after the forming step.
